(19) United States
(12) Patent Application Publication
(10) Pub. No.: US 2020/0074878 A1
(43) Pub. Date: Mar. 5, 2020

(54) Interactive participant choice by acclamation of final plot developments for arranged grouped events

(71) Applicant: Peter Hertsgaard, Charlottesville, VA (US)

(72) Inventor: Peter Hertsgaard, Charlottesville, VA (US)

(21) Appl. No.: 15/932,607

(22) Filed: Mar. 26, 2018

(51) Int. Cl. G09B 19/00

(52) U.S. Cl. CPC G09B 19/00

(57) ABSTRACT

A Learning Management System with control mechanisms that interactively engage structured and improvisational content-based storytelling techniques with responsive participants in-situ and in grouped audiences within a live, real-time, interactive, arranged group performance as selected by acclamation of a chosen plot developed storyline, organized as a learning event, including processes and procedures for selection, review, updating and change management, with approvals by a Client and Sponsor styled affirmation and control methodology.

This patent in application claims a priority benefit of Provisional patent U.S. 62/710,049 dated Feb. 8, 2018; and by Copyright, Library of Congress, Feb. 6, 2018, entitled: “Arranged Grouped Events with Acclamation of Final Plot Development for Interactive Participants”

### Interactive Participant Choice by Acclamation of Final Plot Developments for Arranged Grouped Events

| | |
|---|---|
| INVENTOR & | Peter Hertsgaard |
| APPLICANT | P.O. Box 2317 |
| | Charlottesville, Va. |
| | USA- 22902-2317 |

### International Classes

| | |
|---|---|
| G06F 3/00 | 2006 January |
| G06F 15/16,173 | 2006 January |
| G06Q 10/00,06,10 | 2012 January |
| G06Q 50/20 | 2012 January |
| G09B 3/00 | 2006 January |
| G09B 5/00,06,08,15 | 2006 January |
| G09B 7/00,02,04 | 2006 January |
| G09B 7/00 | 2013 January |
| G09B 19/00 | 2006 January |

CPC Selected: G06Q 10/06 [2013.01], G06Q 10/10 [2013.01], G06Q 50/20 [2013.01], G09B 5/00 [2013.01], G09B 5/06 [2013.01], G09B 5/10 [2013.01], G09B 5/14 [2013.01, G09B 7/00 [2013.01], G09B 7/02 [2013.01], G09B 19/00 [2013.01]; H04L 29/08099 [2013.01]

USPC Selected: 434/322, 434/323, 434/350, 434/362.

### U.S. Patents

| | | | |
|---|---|---|---|
| 4,360,345A | November 1982 | Hoa | 434/262 |
| 4,459,114A | July 1984 | Barwick | 434/307R |
| 5,176,520A | January 1993 | Hamilton | 379/93.19 |
| 5,565,316A | October 1996 | Kershaw et al | 434/322 |
| 5,767,897A | June 1998 | Howell | 348/14.07 |
| 5,827,070A | October 1998 | Kershaw et al | 434/322 |
| 6,008,807A | December 1999 | Bretschneider et al | 345/732 |
| 6,024,577A | February 2000 | Wadahama et al | 434/322 |
| 6,125,356A | September 2000 | Brockman et al | 705/37 |
| 6,155,840A | December 2000 | Sallette | 434/323 |
| 6,433,784B1 | August 2002 | Merrick et al | 345/473 |
| 6,519,763B1 | February 2003 | Kaufer | 706.21 |
| 6,606,480B1 | August 2003 | L'Allier et al | 434/362 |
| 6,684,027B1 | January 2004 | Rosenberg | 386/244 |
| 6,705,869B2 | March 2004 | Schwartz | 434/219 |
| 6,725,219B1 | April 2004 | Nelson et al | 707/10 |
| 6,728,753B1 | April 2004 | Parasnis et al | 709/203 |
| 6,736,642B2 | May 2004 | Bajer et al | 434/322 |
| 6,766,356B1 | July 2004 | Krautter | 709/204 |
| 6,813,473B1 | November 2004 | Bruker | 434, 350 |
| 6,827,578B2 | December 2004 | Krebs et al | 434/118 |
| 6,845,229B2 | January 2005 | Notomi | 434/350 |
| 6,865,368B2 | March 2005 | Hoyashita et al | 434/350 |
| 6,884,074B2 | April 2005 | Theilmann | 434/118 |
| 6,915,104B2 | May 2005 | Yonezu | 434/350 |
| 6,915,105B2 | May 2005 | Masada | 434/350 |
| 6,965,751B2 | November 2005 | Koga et al | 434/350 |
| 6,975,833B2 | December 2005 | Theilmann et al | 434/350 |
| 6,996,366B2 | February 2006 | L'Allier et al | 434/362 |
| 7,014,467B2 | March 2006 | Krebs et al | 434/118 |
| 7,016,949B1 | March 2006 | Tagawa | 709/223 |
| 7,029,280B2 | April 2006 | Krebs et al | 434/118 |
| 7,050,753B2 | May 2006 | Knutson | 434/350 |
| 7,058,891B2 | June 2006 | O'Neal et al | 715/730 |
| 7,092,669B2 | August 2006 | Sakai et al | 434/350 |
| 7,242,389B1 | July 2007 | Stern | 345/158 |
| 7,260,355B2 | August 2007 | L'Allier et al | 434/362 |
| 7,293,025B1 | November 2007 | Harouche | 707/10 |
| 7,315,826B1 | January 2008 | Guheen | 703/27 |
| 7,369,808B2 | May 2008 | Wessner et al | 434/350 |
| 7,371,070B2 | May 2008 | Hamilton et al | 434/322 |
| 7,391,432B2 | June 2008 | Terada | 348/14.08 |
| 7,413,422B2 | August 2008 | Okunishi et al | 434/323 |
| 7,558,853B2 | July 2009 | Alcorn et al | 709/225 |
| 7,603,324B2 | October 2009 | Hamilton et al | 706/12 |
| 7,631,254B2 | December 2009 | Layard et al | 715/202 |
| 7,788,207B2 | August 2010 | Alcorn et al | 706/49 |
| 7,840,649B2 | November 2010 | Pabst | 709/219 |
| 7,860,736B2 | December 2010 | Draper et al | 705/7 |
| 7,870,193B2 | January 2011 | Hintermeister | 709/204 |
| 7,873,588B2 | January 2011 | Sareday et al | 706/47 |
| 7,914,288B2 | March 2011 | Cowherd et al | 434/219 |
| 7,925,673B2 | April 2011 | Beard | 707/802 |
| 7,927,105B2 | April 2011 | Griffin et al | 434/219 |
| 8,108,327B2 | January 2012 | Krebs | 706/14 |
| 8,121,874B1 | February 2012 | Guheen | 705/28 |
| 8,224,757B2 | July 2012 | Bohle | 705/326 |
| 8,271,420B2 | September 2012 | Everhart et al | 706/49 |
| 8,271,631B1 | September 2012 | Horvitz et al | 709/223 |
| 8,315,893B2 | November 2012 | Yaskin et al | 705/7.11 |
| 8,356,997B1 | January 2013 | Bergeron | 434/323 |
| 8,358,965B2 | January 2013 | Allen et al | 434/362 |
| 8,402,055B2 | March 2013 | Cepuran et al | 707/781 |
| 8,597,031B2 | December 2013 | Cohen et al | 434/323 |
| 8,602,793B1 | December 2013 | Sniedzins | 434/322 |
| 8,602,794B2 | December 2013 | Cohen | 434/323 |
| 8,666,056B2 | March 2014 | Makagon | 379/265.01 |
| 8,684,747B1 | April 2014 | Bergeron | 434/323 |
| 8,693,943B2 | April 2014 | Allen et al | 434/362 |
| 8,696,364B2 | April 2014 | Cohen | 434/323 |
| 8,714,987B2 | May 2014 | Cohen | 434/323 |
| 8,731,455B2 | May 2014 | Colby et al | 434/350 |
| 8,738,556B2 | May 2014 | Sadler | 706/45 |
| 8,745,222B2 | June 2014 | Cai et al | 709/225 |
| 8,754,924B1 | June 2014 | Shane | 348/14.05 |
| 8,768,240B2 | July 2014 | Packard et al | 434/362 |
| 8,784,113B2 | July 2014 | Bridges et al | 434/322 |
| 8,838,015B2 | September 2014 | Packard et al | 434/350 |
| 8,848,019B1 | September 2014 | Shane | 348/14.05 |
| 8,887,047B2 | November 2014 | DiGiantomasso | 715/705 |
| | | et al | |
| 8,918,919B1 | December 2014 | Peters et al | 725/78 |
| 8,972,859B2 | March 2015 | Saoummi | 715/707 |
| 9,009,651B2 | April 2015 | Kumar et al | G06Q 10/06 |
| 9,064,232B2 | June 2015 | Laine et al | G06Q 10/10 |
| 9,064,291B2 | June 2015 | Venkataraman | G06Q 50/20 |
| | | et al | |
| 9,077,803B2 | July 2015 | Makagon | G06Q 10/0631 |
| 9,116,889B2 | August 2015 | Muller et al | G06F 17/30011 |
| 9,141,827B2 | September 2015 | Ho et al | G06F 21/629 |
| 9,229,929B2 | January 2016 | Kapoor | G06F 17/289 |
| 9,324,239B2 | April 2016 | Krebs et al | G09B 5/00 |
| 9,348,662B2 | May 2016 | Kurita et al | G06F 9/54 |
| 9,466,222B2 | October 2016 | Laine et al | G09B 7/00 |
| 9,472,114B2 | October 2016 | Morarin et al | G09B 7/00 |
| 9,495,882B2 | November 2016 | Cohen et al | G09B 5/04 |
| 9,498,704B1 | November 2016 | Cohen et al | A63F 9/183 |
| 9,514,437B2 | December 2016 | Becker et al | G06Q 10/10 |
| 9,553,841B1 | January 2017 | Skinner et al | H04L 51/32 |
| 9,563,676B2 | February 2017 | Kapoor | G06F 17/30554 |
| 9,584,565B1 | February 2017 | Ho et al | H04L 65/403 |
| 9,626,875B2 | April 2017 | Gal et al | G09B 5/08 |
| 9,633,358B2 | April 2017 | Kolowich et al | G06Q 30/201 |
| 9,652,725B2 | May 2017 | Muller et al | G06Q 10/06 |
| 9,691,292B1 | June 2017 | Acosta | G09B 5/10 |

### U.S. Patents in Application

| | | | |
|---|---|---|---|
| 2002/0029161A1 | March 2002 | Brodersen | 705/7.14 |
| 2002/0078441A1 | June 2002 | Drake et al | 725/9 |
| 2003/0110228A1 | June 2003 | Xu | 709/207 |
| 2003/0227479A1 | December 2003 | Mizrahi et al | 345/753 |
| 2004/0002048A1 | January 2004 | Thurmaier et al | 434/350 |
| 2004/0002049A1 | January 2004 | Beavers et al | 434/350 |
| 2004/0043362A1 | March 2004 | Aughenbaugh et al | 434/118 |
| 2004/0121299A1 | June 2004 | Rougeau et al | 434/350 |
| 2005/0003330A1 | January 2005 | Asgarine et al | 434/20 |
| 2005/0089834A1 | April 2005 | Schapiro | 434/323 |
| 2005/0160014A1 | July 2005 | Moss et al | 705/26 |
| 2006/0059253A1 | March 2006 | Goodman | 709/223 |
| 2007/0162907A1 | July 2207 | Herlocker | 718/100 |
| 2007/0245305A1 | October 2007 | Amderson | 717/110 |
| 2008/0013705A1 | January 2008 | Yoffie | 379/201.12 |
| 2008/0021740A1 | January 2008 | Beane et al | 705/3 |
| 2008/0021757A1 | January 2008 | Majd | 705/7.15 |
| 2010/0185474A1 | July 2010 | Frank | 705/7.15 |
| 2010/0197278A1 | August 2010 | Anderl | 455/412.1 |
| 2010/0235395A1 | September 2010 | Cepuran | 707/783 |
| 2011/0121938A1 | May 2011 | Slemmer | 340/3.1 |
| 2011/0208822A1 | August 2011 | Rathod | 709/206 |
| 2011/0225293A1 | September 2011 | Rathod | 709/224 |
| 2011/0276396A1 | November 2011 | Rathod | 705/14.49 |
| 2012/0192086A1 | July 2012 | Ghoda | 715/753 |
| 2012/0198414A1 | August 2012 | Chen | 717/102 |
| 2013/0247055A1 | September 2013 | Berner | 718/102 |
| 2013/0342415a1 | December 2013 | Verstraete | 340/7.51 |
| 2014/0074629A1 | March 2014 | Rathod | 705/14.73 |
| 2014/0129605A1 | May 2014 | Huang | 700/201 |
| 2014/0129942A1 | May 2014 | Rathod | 715/720 |
| 2014/0157148A1 | June 2014 | Joo | 715/752 |

### Foreign Patent Documents

| | | |
|---|---|---|
| WO | WO8505715 | December 1985 |
| GB | 2271262 A | April 1994 |
| JP | 10123923 A | May 1998 |
| JP | 20001330464 | November 2000 |
| JP | 2002007586 A | January 2002 |
| JP | 200272843 A | March 2002 |
| JP | 2002116684 A | April 2002 |
| WO | 0227458A1 | April 2003 |
| JP | 2002156894 A | May 2002 |
| JP | 2003280506 A | October 2003 |
| JP | 2003323387 A | November 2003 |
| JP | 200489601 A | March 2004 |
| KR | 10-0040942 | May 2004 |
| JP | 2004240234 | August 2004 |
| JP | 2004333525 A | November 2004 |
| JP | 2005025399 A | January 2005 |
| KR | 10-0001391 | January 2006 |
| KR | 10-0601397B | July 2006 |
| CN | 1809868 A | July 2006 |
| JP | 2007504517 A | March 2007 |
| JP | 3930022 B2 | June 2007 |
| KR | 10-0078750 A | August 2008 |
| WO | 2008-143297A1 | November 2008 |
| KR | 10-0001697 A | January 2009 |
| WO | 2013-086513A2 | June 2013 |
| WO | 2013-103947A2 | July 2013 |
| EP | 2 728 541 A1 | July 2014 |

### OTHER REFERENCE MATERIAL

By Copyright, Library of Congress, Feb. 6, 2018, entitled: “Arranged Grouped Events with Acclamation of Final Plot Development for Interactive Participants”

### FIELD OF THE INVENTION

This invention relates to storytelling with actors and an audience prepared to choose the final storyline outcome by acclamation. A moderator interrupts the storyline points of decision to open a discussion with the audiences for the choices to be considered, and the moderator will select one of the several possible choices from the acclamation of the audience. The final choice will then proceed with the cast of actors to perform the storyline selected.

This invention is classified best in The United States Patent & Trademark Office [USPTO] in Class 434: Education & Demonstration. A further classification in the current America Invents Act [AIA] with its International Codes will be found in CLASS G: Physics; and in CLASS H: Electricity. These International Classes contain data for electronic performance, but have within their sub-listings the activities of the US Class 434 that will cover this invention in its applicable non-electronic format.

This patent in application structures procedures to interview and pre-select participants from the client's requirements wherein all said pre-selected participants are prior approved by the client. The elements and issues and the narrative storyline are to be outlined to these pre-selected participants for their consideration and understanding before and during the actual event. These participants can then be assembled into an arranged grouped event wherein the choices of a best final plot ending will be discussed and chosen by a vote with voice acclamation.

This activity and method will be unique and is not obvious to anyone in prior patent art.

### BACKGROUND OF THE INVENTION

While in this stated venue of ‘arranged grouped events’, it is intended that the ‘plot development’ follow traditional narrative storylines, it seems in current delivery that these forms that produce a storyline can include the brief phrases of expository statements without verbs or summary periods as used in sentences. Also, such narrative phrases can expand to diagrams, figures, drawings, lists, charts, tables, images and such to convey brief impacts of knowledge without any formal structure or learning. This form seems preferred today as a very foreshortened brief summation of non-narrative forms. All of such combined elements and issues can format into a pre-selected storyline wherein the participants are to be versed to evaluate and consider several choices of the final plot ending of such a storyline as the very most compelling and best selection to achieve learning and understanding for such a presented situation.

As this format will present a contrived situation involving pre-selected participants who are interviewed and approved, by the Client who will present this arranged grouped event, and what is to be achieved is a learning management system, wherein the final plot ending of a story will be by participants' choice. Such an event is common enough in the school classroom wherein a roll is taken and those enrolled are required to be present for proper credit on an academic course for a degree, as such is an ‘arranged grouped event’ at each session of the classroom. This structure is again seen in the corporate and marketing arenas wherein it is informational and presented to an ‘arranged group event’ for its development and feedback on the data presented. Similar occurrences are to be experienced in the military and government arenas wherein the participants are pre-selected and approved for receiving the information and data to be presented to such a group. Many new products are demonstrated and developed, even with comments and feedback that can bring about improvements prior to public sales, by the marketing and new concepts team of corporate and industrial industries that will seek the interaction with pre-selected participants. In all of these scenarios, an arranged group: can be in one event in one location, or in multiple locations that reach wider markets and business interests even around the world.

Many such ‘arranged’ presentations in the ‘grouped event’ seek to learn reactions to new items of merchandise and service, just as presented herein this patent application. The pre-selected participants are known from earlier interviews to have the needed skills and interests to consider and vote for some best choices in such a development. The elements and issues at hand can range over a wide field of interest from the simple application to the complex means to evaluate the item and service shown. In bringing out responses the possibility exists for many thoughts and ways to best introduce a solid and acceptable item and service.

When choices emerge for a “best use”, then the final choice and purpose: can be acclaimed by a voice vote for a final product or final storyline ending for the issue at hand that is then determined from the acclamation by voice vote by the participants. In order to achieve the one best final plot ending of the pre-selected storyline, there will be places in this chosen story wherein such issues would obtain a point of decision to be interrupted by a Moderator who would interact with the participants to discuss several, if not many, choices of a final plot ending best suited for the assembled group. In the middle of the storyline, a Key Control Point (KCP), would be reached wherein such new directions can be developed into a selectable final plot ending. The Moderator manages the KCP as this interactive opportunity to select a different storyline path is made apparent by the participants' acclamation activities. Such a moment can be designated as a ‘point of decision’ wherein the storyline can go in any of several directions as its final ending. The actors that portray the initial storyline, would of necessity await the participants' choices to perform whichever type of ending then chosen.

This moment would be the interactive feature for the ‘arranged grouped event’ and this moment would be the point of decision in the plot of a storyline wherein several different directions can be decided upon for the final ending. The storyline would have a logical place for this event to be interrupted to discuss how to proceed with the final plot ending, and wherein the several likely choices that will accrue to a Moderator who will offer these best choices to the audience. The ‘arranged group’ shall interact and discuss with the Moderator their best selections and the best way for the final plot development, through the Moderator's guidance. Of the several, even many, possibilities that can be taken, the Moderator shall select one or more choices for the participants, and they shall choose one by voice acclamation as the best selection for the final plot ending. The actors will then proceed to present the final plot ending as selected.

In the prior patent art it is rare and limited wherein any such an interactive activity would be undertaken, and where the ‘arranged group’ such as a classroom would be cited to be involved in the discussion and choice of a best storyline path to develop. Such an activity is not even presented as a patented measure for educational institutions or other teaching activities as an interactive participant measure.

In a review of this unique and adaptive patent in application, herein cited from Abernoth's “History of Media” [pp. 69-70] wherein is found a specific instruction exclaimed: “Creation and distribution of content within a structural platform may be referred to as a learning management system for the benefit of a single participant and may include multiple participants at a single location, as well as, at distributed locations, and may include bystanders that become limited participants as well. Such systems have historically provided significant features and capabilities that enhance the effectiveness and delivery of multi-media content to a single participant and to groups of participants no matter their location, time period, methodology, tracking, surveys and questionnaires, results including rating and aggregation of scores, data, and information. Over time, learning management systems advance with new features and capabilities such as; enabling enhanced interactions, participant management, and resulting in content evolution. This invention provides a platform for unique and hybrid processes and procedures to occur within an enhanced event framework while allowing for the variable real time interactive creative content of design, implementation, and iteration; to commence, evolve, and render as dynamically produced with especially customized characteristics of a content evolution event.”

A review of the background and history of such an activity as detailed herein, wherein the involved participants are interactive with a Moderator to select, in their view, the single best final plot ending to achieve an objective and true best presentation of a storyline topic pre-selected by a Client.

In a best embodiment that can be developed from past art, there is to follow some examples in related art of media:

### Historiography of Media

The history of the performance art for broadcast media the modern world became typified when broadcast television became available in the U.S. market around the 1950's. Earlier performance art was defined by its content delivery location, albeit theaters, concert halls, meeting rooms and such. Even live actor performance content delivered via radio still required a studio for creation of the content and an audience via a radio station's local listeners to complete the consumer market model.

Modern Broadcast Content Evolution
1. Live Broadcast Radio;
2. Live Broadcast TV [television];
3. Broadcast TV utilizing video-taped performance that was previously recorded, edited, then broadcasted on a schedule, not defined by live event constraints;
4. Scheduled Broadcast TV with intermingled Live Broadcast for a hybrid version of performance art;
5. Offshoots of the live performance art continued to be delivered to audiences onto different content delivery platforms such as Video Tapes, Cable TV, Satellite TV and CD-ROM [Compact Disc-Read Only Memory] Disks, and DVD [Digital Video Disk].
6. Since the inception of the U.S Governmental DARPA [Defense Advanced Research Projects Agency] network for electronic communications, and its successor, the Internet; new channels of content delivery and an unlimited host of content providers have emerged. These content providers use similar live actor performances for content creation, modify elements of their creation by artificial means such as computer generated graphics, and stand-in live actors with synthetic versions of themselves, even wholly created synthetic actors not based on a known actor's physical characteristics;
7. Modern Broadcast Content exists today [2017] and described as live, and archival, with broadcast distribution through traditional means such as, over the airways, through a defined cable and connective medium, streaming via internet, all to a myriad of devices and platforms.

These components of creative content for broadcast have focused on the performance art with little change in the storytelling process until the advent of this live, real time, interactive, creative content framework that encompasses storyline elements through the traditional dramatic forms of; drama, comedy, tragedy, musical, fantasy, romance, and the like as performed.

This patent in application structures procedures to interview and pre-select participants from the Client's requirements wherein all such pre-selected participants are prior approved by the Client and Sponsor. The elements and issues and the narrative storyline are to be outlined to these pre-selected participants for their consideration and understanding during the actual event as approved by Client and Sponsor. These participants can then be assembled into an arranged group events wherein the choices of a best final storyline ending will be discussed and chosen by a vote with voice acclamation.

This activity and method will be unique and is not obvious to anyone in prior patent art.

It will be seen that many special and adapted terms will appear in this patent in application, and the explanation of such terms would be placed herein in a Glossary to follow in preparation for the Summary and Claims wherein such terminology would be found.

### Glossary

[to be presented as placed into use, and in groupings of use]

It is advantageous to define and establish the meanings of several terms utilized in describing the invention.

Where the definition of identified terms herein departs from the commonly used meaning of the term, applicant intends to utilize the definitions provided herein, unless specifically indicated.

For the purposes of the present invention, these terms refer to the following meanings:

### Alternative Story Development/ASD:

An alternative story development utilizing evocative, inductive, revealed, multi-dimensional, unique and mystical knowledge sets, intentions, approaches, systems, models, awareness, discoveries, meanings, processes, teachings and learnings; creative components of said forms include: signs; signifiers; symbols; glyphs; shapes; hieroglyphs; ideas; archetypes; language characters; codes; ciphers; cybernetics; holograms; music; mandalas; geometries; numbers; formulas; astrological and cosmological arrangements and attributes; sounds; vibrations; frequencies; silence; meditation; prayer; inspiration; dreams; visions; multi-dimensional consciousness experiences; scriptures; thought forms; chromatic codes and arrangements; non-traditional images, sounds, meanings, words, syllables, expressions, philosophies, research, texts and storyline models; innovative, unusual, altered, hybrid and transformed versions of Traditional Storyline Development elements; and in all combinations; Alternative Storyline Developments may exhibit non-linear, omni-linear, and sidestream models of storyline dynamics and evolution; said models may evolve, mutate, and interface to, from and with other storyline movement and evolution models.

### BACKGROUND

The pertinent story information, explicitly and implicitly presented, giving depth, breadth, expansion and sometimes alternate versions of plot and setting elements.

### Change Agent:

Within the LRTILE, an Interactive Event, the change management process, an Interactive Event collaborator whose interactive, expressive and ongoing engagement with storyline and learning content elements may become a force of change, metamorphosis and transformation for any an Interactive Event collaborator

### Change Management Process/CMP:

In the an Interactive Event an unfolding, dynamic, interactive and participative experience in which a group of people mutually engage in observing, feeling, contemplating, reacting to and collaboratively and mindfully altering a set of storyline elements, and especially the beliefs, values, awareness, actions and the levels and states of consciousness of characters in the Interactive Case Study; the an Interactive Event change management process is comprised of the following: audience members as observers, indirect participants, direct participants and co-creators; actors as performers, characters, instructors, facilitators and co-creators; creators as instructors, facilitators and arbiters; Moderators as facilitators, instructors, evaluators, arbiters, and co-creators; singularly, and in combination.

### Consciousness Time Spaces/CTS:

The inner spaces of the mind, where consciousness stimuli are received, evaluated, characterized, judged and stored, and which are defined as subjective, objective and a sliding scale of both subjective and objective (in essence) by the receiver; said judgments of consciousness stimuli as subjective and objective may be utilized in making assessments, evaluations and judgments regarding the sophisticated, nuanced and holistic arrangement of consciousness stimuli in the future; in this ongoing and evolving experiential process, the definition, judgment and utilization of discrete and holistic elements of consciousness stimuli may in the individual and the collective units switch from subjective to objective and from objective to subjective definitions, judgments and utilizations; thus, within the journey through the interfaced multi- and inter-dimensional consciousness times and spaces of the mind, which may be characterized by entrainment dynamics, the phenomena of consciousness time spaces may evolve with fluid, mutable and often mysterious patterns.

### Inspirational Forces/IF:

The non-corporeal forces, storyline insight, that positively influence any component of storyline, learning, and human consciousness, input and interaction in the Interactive Event, and thus whose expression and impact may manifest through corporal forms.

### Interactive Case Study/ICS:

A finished Live, Real-Time, Interactive, Learning, Event, Creative Content script, utilized in a Interactive Event, which contains various elements and components representing an entirety of a Traditional Storyline Development or an Alternative Storyline Development, and which may also include: insights; awareness; understanding; meaning; knowledge; wisdom; beauty; truth; ethics and morality; perceptions and evolving states of consciousness and multi-dimensional awareness; with linear, non-linear, omni-linear, sidestream storyline movements, which in dynamics and evolution may be interfacing, symbiotic, and mutating in nature, whether singular or in combination.

### Interactive Learning Event Assessment/ILEA:

The surveys, evaluative instruments, assessments, measurement tools, feedback and other educational and research methods, models and approaches that endeavor to elevate awareness of self, others and the world, and to increase the effective utility of said awareness in the living of life; said assessment, measurement and feedback tools, systems, methods, instruments, surveys, models and approaches are integrated in a customized fashion into both the storyline elements of the Interactive Case Study and into learning content essence, assessment and evaluation filters presented and managed by the Moderators.

### Key Control Points/KCP:

The dynamic, interactive, live and aggregating thresholds of shared human input at specific interfaces within the Interactive Event process; said key control point interfaces are equally identified as “points of decision” and are comprised of interactions among Interactive Event collaborators; said interactions include: question and answer styled discussion sections with characters; coaching of characters; redo of character interactions; freezing of characters in midst of interaction with different characters; ongoing discussion and debriefing of various story and learning content elements, which may include discussion of the motives, values, beliefs, actions, inactions, challenges, hopes, fears, sorrows, confusions, angers, physical, mental, emotional and spiritual blockages, and all other states and levels of internal and shared consciousness and awareness; and verbal and non-verbal communications evidenced by characters; ongoing and deepening discussion and evaluation of and mindful adjustment to the evolving storyline elements, facilitated by the Moderator, including filtering all parts of the Interactive Event through various learning modalities, paradigms, systems, approaches, and philosophical, scientific and spiritual models and principles, standards of proof, and human learning diagnostic and evaluative tools, models and processes, within the Learning Management System.

### Learning Management System/LMS:

The Learning Management System refers to an operational platform with a framework consisting of creative and learning components enabled singularly; with the ability to interweave multiple, combined creative and learning components into a presentational Interactive Case Study, containing live, real-time, interactive learning event creative content referencing one or more defined time space consciousness continuums under the management control of the Interactive Event Moderator, Director and Producer, utilizing Key Control Points to advance the interaction of creative and learning content components into the sophisticated and applicable consciousness spaces' timelines of an Interactive Event.

### Live, Real-Time, Interactive Learning Event/LRTILE:

An arranged group event experience where audience members and Moderators may actively participate in an open-ended, self-organizing process of learning by offering a quantum of their consciousness to the inner and outer worlds, and actions, of characters, through the direct communication means of live, real-time, interactive question and answer, coaching, freezing (‘in the moment’ coaching) and playing of characters; key control points of Live, Real-Time, Interactive, Learning, Event (LRTILE)s occur before, during and after scenes between and among characters, audience members and Moderators, and may impact subsequent interactions between and among characters, audience members and Moderators, an Interactive Event; thus, audience members and Moderators are active and influential participants in the Interactive Event, and through the Interactive Event may thus become co-creators in the evolving story; audience members and Moderators, thus, also function as change agents when engaging in Interactive Events, with interactions which may have a therapeutic aspect and impact to their expression; in this process, audience members learn about the characters, setting and background of Interactive Case Study (ICS), through information provided to them by the Moderator and through the observation of and interaction with the characters; the interaction among audience members, Moderators and characters may be filtered through various learning modalities, philosophies, paradigms, standards, systems and models, which in form, essence and expression, may be: archetypal; philosophical; therapeutic; spiritual; pragmatic; customized; legal; lawful; ethical; scientific; emotional; sociological; biological; nuanced; Interactive Events may occur in a live time state; Interactive Events may also occur when utilizing pre-recorded Live, Real-Time, Interactive, Learning, Event, Creative Content (LRTILECC).

Live, Real-Time. Interactive Learning Event Audience/LRTILEA:

A living entity participating in an Interactive Event who interacts with Traditional Storyline Development and Alternative Storyline Development elements, and Interactive Event Moderators, Directors, Creators, Participants, Non-Participating audience members, Producers and Designers towards the goal of gaining greater awareness, understanding, knowledge, meaning, truth and wisdom about themselves, others and the universe; said audience members have free will choice in how much and how little they participate in the Interactive Event, which may involve audience members choosing to become characters acting in the Interactive Case Study; audience members may be in the live setting where the Interactive Event is being presented; audience members may be in a setting remote from but connected to the live setting of the Interactive Event; audience members may interact with a pre-recorded version of the live setting of the Interactive Event; audience members may also participate in responsive surveys, evaluations, assessments, feedback, coaching discussions and voting related to various storyline and Moderator learning content elements present in the Interactive Event.

### Live, Real-Time, Interactive Learning Event Creative Content/LRTILECC:

The creative elements of Traditional Storyline Development and Alternative Storyline Development (whether in written, recorded, spoken, sung, broadcast, projected, chanted, whispered, printed, streamed, blogged, tweeted, instagrammed, emailed, teleconferenced, or transmitted modes, and whether in isolation or combination) as follows: words; ideas; images; rhythms; text; dialogue; messages; sounds; music; syllables; thoughts; silence; all shades, values and intensities of light, shadow and color; faces; bodies; voices; non-verbal communication; body language; all expressive values of vocal communication; crystalline shapes, vibrations and frequencies; cosmic and inspirational expressions, influences and interfaces; all arrangements, combinations, alterations and transformations of said creative components, and all evolving arrangements, combinations, alterations and transformations of said creative components, whether in live or pre-recorded time states, including all connections between and among said creative components in all states of consciousness time and space that facilitate all live, real-time, interactive learning event states described herein.

### Live, Real-Time, Interactive, Learning Event Moderator/LRTILEM:

The one who moderates Interactive Events; Moderator mediates between and among all Interactive Event Collaborators; the Moderator serves as a nexus between and among Interactive Event collaborators, and thus performs an arbitrating function among the various evaluative assessment, feedback, evaluative, discussion and coaching inputs offered to Interactive Event characters by Interactive Event Collaborators; Moderator's judgment of the value of said inputs may be filtered through ethical, spiritual, scientific, intellectual, emotional, rational, biological, cosmic, legal, philosophical, universal, common sense, archetypal and aesthetic standards, paradigms, models, systems, philosophies and approaches; the arbitrating process facilitated by the Moderator thus acknowledges, incorporates, evaluates and judges the subjective and objective reception, processing, evaluation and judgment models evidenced by the audience members, characters and other Interactive Event collaborators; the Moderator utilizes Key Control Points among the interacting and evolving human forces of the change management process explicit and implicit in the Interactive Event.

### Non-Linear Plot Model/NLPM:

In an Alternative Storyline Development where a story may: start at the end of the story and move backwards towards the beginning of the story; start at the middle of the story and move towards the end and then towards the beginning of the story; start at the middle of the story, move towards the beginning, then move towards the end of the story; start at the beginning, of the story, move towards the end, then move towards the middle of the story; start at the end of the story, move towards the beginning, then move towards the middle of the story; move in storyline paths different than the linear “beginning>middle>end model” of Traditional Storyline Developments.

### Omni-Linear Plot Model/OLPM:

An Alternative Storyline Development where an original quantum of storyline elements may develop, grow and transform simultaneously in a variety of storyline paths, creating new, autonomous stories, which in their new forms may still exhibit some quantum of their original set of storyline elements, and which in the evolution of their new story paths may reconnect with some quantum of the original, shared storyline elements; and which may also connect with different newly-created stories which arose from the shared, original quantum of storyline elements.

### Plot A:

A combination of the following storyline elements: 1) characters, their beliefs, values, wants, needs, hopes, fears, sorrows, confusions, guilts, dreams, mysteries, enigmas and all states of consciousness, and all actions initiated, suppressed, repressed, denied, altered, accepted, integrated, transformed, dismissed and judged within themselves and between and among other characters, and re-actions initiated, suppressed, repressed, denied, altered, accepted, integrated, transformed, dismissed and judged within themselves and between and among other characters, resulting in entangled, evolving, dynamic, metamorphosing, mysterious and ultimately resolving interactions within, between and among characters; 2) details, expansions, shadings and alternate versions of setting, background and character elements introduced by creators; and, 3) the dynamics and evolution of characters' actions and re-actions through time and space in the linear “beginning>middle>end model” of Traditional Storyline Development.

### Plot B:

A combination of the following storyline elements: 1) characters, all states and levels of consciousness, feelings, beliefs, values, actions and re-actions initiated, suppressed, repressed, denied, altered, accepted, integrated, transformed, dismissed and judged within themselves and between and among other characters, resulting in entangled, evolving, dynamic, metamorphosing, mysterious and ultimately resolving interactions within, between and among characters; 2) details, expansions, shadings and alternate versions of setting, background and character elements introduced by creators; 3) the dynamics and evolution of characters' actions and re-actions through time and space in the linear “beginning>middle>end model” of Traditional Storyline Development.

### Real-Time:

The elapse of measurable physical, linear time within the Interactive Event experience in which there is a real, tangible shift in the individual and collective consciousness states, levels and awareness of the individual as well as the group of individuals participating in an Interactive Event.

### Setting:

The places, times, eras, and cultural milieus of a storyline.

### Storyline:

The comprising of properties such as: settings, background, plot, and implies interactive evolution of said properties including; actors, maps, graphics, visuals, and projected images wherein the storyline is extended to introduce such material into its plot development of a Traditional Storyline Development and equally in an Alternative Storyline Development, at a Client's request.

### Sidestream Plot Model/SPM:

An Alternative Storyline Development where a set of storyline elements unfold in parallel orientation to another set of storyline elements; these multiple sets of storyline elements are linked through at least one shared creative component of an Alternative Storyline Development and equally with a Traditional Storyline Development.

### Traditional Story Development/TSD:

The setting, background and plot elements of a storyline.

The Interactive Case Study (ICS) Process is comprised of the following eight phases and describes the sequential nature as well as, the opportunity to incorporate the herein defined skillsets and elements.

Furthermore, the Interactive Case Study follows an outline that is described as a phased approach, meaning that the processes and procedures that create input source content and direction are contained and thereby discovered within each identified Phase. Altogether, these eight Phases provide an overall outline that culminates into the creation of the Interactive Case Study.

PHASE 1: Defining learning goals and vision for Interactive Case Study plus first set of interviews.

In this phase, the overall vision for the goal of the learning and how Interactive Case Study will be integrated into the overall goal is defined. In addition, the interfaces between Interactive Case Study and the other modules of the learning are discussed and defined, which includes other “filters” to be integrated into the interactive case study: Client competencies; assessment tool facets/capabilities; Client, facilitator, and learning modalities; etc.

These discussions are immediately followed by the first round of [confidential] interviews, which are of a comprehensive, evolving and progressively deepening nature. Interviewees are chosen by the Client, with the guidance that those chosen be individuals with the distinct skillsets:
a) experience and knowledge of the issue/human dynamics targeted for the learning
b) good communication skills
c) an open, balanced mind—i.e., people without an axe to grind
d) a commitment to making things better
e) courage to speak the truth (not just ‘their truth’).
   PHASE 2: A second set of interviews, plus emerging vision of interactive case study elements.

In this phase, promising ‘leads’ for the setting, background, characters and plot movement have been identified from the first set of interviews. In the second set of interviews, these leads will be further investigated and tested against the dramatic, cultural and facilitation goals that have been mutually defined—i.e., the desired experience and impact projected for participants.

Typically, the second sets of interviews have the following characteristics:
a) significant reliance on key interviewees from first set of interviews
b) addition of new interviewees, who fill a void of knowledge, experience and perspective
c) interviews not much shorter in length (if at all) from first set of interviews

During and after this set of interviews, imagination, common sense, intuition, observation and creative judgment are in an accelerated state for the interviewer. When combined with the knowledge and guidance initially provided by the Client, there is an exponential increase in the awareness within the interviewer of a variety of significant dramatic choices related to setting & background, character and plot elements of the case study. And it is these emerging ‘discoveries’ that are conveyed to the Client, in the goal of creating a shared vision of the key dramatic elements (as well as beginning a process of either affirmation or possible redirection of the initial vision provided by Client about the nature of its culture).

PHASE 3: A third set of interviews, plus Client approval of rough outline of case study elements, plus creation of Cultural Identifiers document.

In this phase, the key is the distillation of the majority of the dramatic elements in the case study: setting & background; characterizations; plot movement. As such, the interviews in this round are almost all focused on discovering the depth and breadth of any unresolved questions within the dramatic elements. These are then arranged in a rough outline and presented to the Client, where further refinements are usually made. Once the Client agrees to the major details of the case study, the Cultural Identifiers (CI) document is generated. The Cultural Identifiers document is a detailed yet comprehensive assessment of the Client's culture, including: its business model; cultural truths, challenges, nuances and contradictions; and actual [anonymous] quotes that incisively convey telling feelings, thoughts and ideas about the issues being highlighted in the learning experience.

PHASE 4: A first draft of case study elements: scenes; character bios; background & setting.

In this phase, the Client provides DETAILED feedback on the dramatic elements. Within this process, it is not unusual that further refinement of details with Client personnel, and including interviewees is required to resolve some feedback points. Besides this feedback focus, there is also a “creative” process that the Client begins to engage in at this point—the organic discovery of specific facilitation choices that will help BOTH support and lead the interactive case study experience.

PHASE 5: A refinement and setting of the case study dramatic elements.

This phase entails the final setting of all dramatic elements, as the actors will need to begin creating their characters, thoroughly researching the Cultural Identifiers document and start memorizing their lines. The Background, Setting and Character Bio document (the “one pager”) that is the only handout to the audience is also generated in this phase.

PHASE 6: The offsite rehearsals, plus onsite rehearsals, plus dress rehearsal with Client & facilitators.

This phase is where the case study and the facilitation both come to life. Minor refinements are made to scenes and characterizations, as well as to the facilitation process. The creation and revising of the interactive Q&A, coaching, re-coaching, and Redo sections is also done in this phase.

PHASE 7: The onsite delivery of Pilot Interactive Case Study session.

This phase consists of the presentation of the following interactive case study elements:
a) prep of audience by facilitators of interactive case study experience, which includes—going over the various elements of audience interactive participation & collaboration dynamics with facilitators and actors (in AND out of character); going over the ‘one-pager’ information highlighting the setting, background and character bios of the case study; any special instructions and guidance to audience from facilitators about the process, sequence, content, and protocols of the various interactions between and among the audience, facilitators, actors and characters
b) scenes
c) debriefs led by facilitators with audience participants
d) Q&A sessions with characters, led by facilitators but inclusive of audience participation
e) coaching of characters by audience & facilitators—includes collaborative deliberation, assessment and evaluation of various learning modalities, competencies, behavioral models, etc among audience members as these relate to dynamics within, between and among characters, situations, teams, cultures, etc within the case study
f) freezing and re-coaching of characters by audience and facilitators g) the spontaneous re-doing of previous or playing of new scenes by characters, based on the guidance of facilitators, audience, actors and director.
   PHASE 8: The entrainment dynamics present in the Interactive Case Study.

This phase consists of the aggregation of the following: the sharing and evolution of humanistic goals of learning, imagination, positive intentions, inspirational moments, and elevated consciousness engagement and entrainment with the Client, participants, and all concerned, beginning in Phase 1 and continuing throughout all the other Phases. The specific elements comprising this phase's deliverables are:
a) the ongoing and evolving improvement in awareness of self, awareness of others, and awareness of the energies and dynamics connecting these states of awareness;
b) the ongoing and evolving improvement in the utilization of more positive behaviors in interactions with self and others, including greater skill in the usage of empathy, sympathy, compassion, understanding, trust, wisdom, patience, forgiveness, love, and grace.
c) The ongoing and evolving improvement in the subjective reception of and collaboration with powers of positive spiritual entrainment, within and among multi-levels and dimensions of consciousness, including; observable transformations of participants' baseline levels of mind, body, and spiritual value systems and behaviors.

In the review of the Learning Management System content framework, the following sequentially identified Processes & Procedures boxes assist to understand more fully, the in-depth and breadth that the organization and edit-ability of each Process box step impacts each other Process box step as to allow a myriad of possibilities and combinations of storyline elements via these process boxes coupled with their arrangement. In these following detailed descriptions of FIG. 5, Box 320, and FIG. 6, Box 320, both Processes and Procedures, the term LRTILE, also meaning Interactive Event, is utilized for brevity purposes.

The following are the Learning Management System diagrammatic Box numbers 100 through 1000, these Processes and Procedures are numbered with connective lines forming a sequential step-by-step detailed described process and procedure with additional connecting and looping sequences as indicated.

In FIG. 1 there is seen a diagrammatic chart with the command shown and described as Learning Management System [100] that in turn is detailed and does direct where these preselected activities will be held as in a Location [200] that is described below as a Classroom [301] which is intended to accommodate a small arranged group of 10 to 20, or up to 30 in the space of a normal classroom; or to follow an Event [302] wherein an prior arranged grouped event can be scheduled of many persons in larger facilities such as an seated auditorium, or possibly an indoor or outdoor sporting gym or stadium, or as required. In this FIG. 1 the Learning Management System [100] can be seen to manage such a size as may be needed for an arranged grouped event from the smaller normal Classroom [301] up to a larger size to be of any size as requisite as an Event [302].

FIG. 1 continues the Learning Management System [100] into its Content [210] that has the command of the requisite files to follow as shown and detailed in FIG. 2, and further development is not required here in FIG. 1.

FIG. 1 then continues the Learning Management System [100] into Testing [220] that is where the participants to be involved for these arranged grouped events can be determined for their abilities and skills in order to evaluate the competent and capable Assessment [330] in order to preselect the best of the candidates that interact in the upcoming arranged grouped event. The Evaluation [340] of all participants is conducted under the supervision of the client who will after all considerations are determined, and then, the client will affirm their best choices for the preselected participants to participate in the Event [303].

In the FIG. 2 the Content [210] from FIG. 1 has been expanded to show the steps as projected herein in this patent in application. The first step shows how all content is directed with Content Management [300] and in turn on the next step down this step manages Change Control [400] which will manage versioning and direct the search in the resource files, Container File 1 [500] and Container File 2 [510] for the required storyline. In this diagrammatic chart section is the Container File 1 [500] that opens the search for a Traditional Story Development [600] that might be perfect to use. The additional Container File 2 [510] that opens the search for an Alternative Story Development [610] that might be viewed if the Traditional Story Development [600] proves unacceptable. Although only single citations are needed to demonstrate these important searches, it is implied that the total range for such a search could be enormous and extensive for desired content.

In the FIG. 3 the diagrammatic chart opens up with Content Management [300] from FIG. 2 as shown on the left hand side wherein the Change Control [400] is directed to open a Traditional Story Development [600] to be matched up with several. Alternative Endings [700] for an acceptable storyline to use for an arranged grouped event. If such a matchup is to be found not sufficient or appropriate for the use intended, then we shall proceed to the FIG. 4 that follows to adjust and continue the search for the storyline that is required by the client. Then, the Content Management [300] will enlist and retain Operatives [310] that are on the right side to seek and hire the needed staff and personnel to place the best storylines into action as requisite to portray all such choices as are to be considered for viewing. In order to perform any storyline that may be selected for viewing, the Operatives [310] shall engage a Moderator [410] to proceed with all preselected Participants [420] that have been evaluated and affirmed by the client as shown in FIG. 1. Then, Actors [430] that have been retained and hired to portray each selected storyline to be viewed by the Client [440] shall assemble and undertake to portray as best possible these selected storylines for the client. The Client [440] having viewed all selected storylines, shall render a verdict for the several best presentations to be retained for further consideration in the final voice vote that acclaims the one best storyline to be presented at an arranged grouped event.

In the FIG. 4 a similar diagrammatic chart to FIG. 3 is presented with identical numbering and descriptions throughout except wherein the choice of an Alternative Story Development [610] is introduced with Content Management [300] directing through Change Control [400] on the left side into the selections of alternative storylines including Alternative Endings [710] suitable for the arranged grouped event.

The Operatives [310] as shown on the right side, will endeavor to engage a Moderator [410] for this situation who in turn will present storylines to the pre-selected Participants [420] for their consideration and selections. Those storylines to be considered the best for the purposes of the client will be affirmed by voice acclamation and be presented to the Actors [430]. The Actors [430] shall assemble and determine how best to portray these choices of storylines to all concerned. After due consideration, the selected storylines will be portrayed and be presented to the Client [440] for consideration and approval by affirmation as the one best storyline selected to be used for the arranged grouped event.

This FIG. 4 has shown the requisite development and processes for all of the choices, including the Traditional Story Development [600] with such Alternative Endings [700] shown in FIG. 3, as well as, the Alternative Story Development [610] and their possible Alternative Endings [710] as shown in this FIG. 4. Herein in FIG. 3 and FIG. 4 the best selections of storylines shall be advanced by voice votes of the preselected Participants [420] and by affirmation of the Client [440], and only then, for a one best presentment to the arranged grouped event.

In the following FIGS. 5 and 6 the involvement and exploration into the file containers is shown in the diagrammatic charts that detail how such storylines may be drawn or discovered in these background files that try to develop a satisfactory storyline for an event.

In the FIG. 5 the first item at the top is Container File 1 [500] that will open the files of the Traditional Story Development [600] through the normal Processes [320] that receives from time to time an Update [325] when such a need becomes evident herein, and also as an Update [325] as seen and directed to FIG. 7 for its own merit. Processes [320] control and in turn open the subset block of file storage areas when needed. The first to be shown in the inset of this subset block is Live [450] as directed for a live seated audience at the event. Then, it is Real Time [460] wherein the storyline selected would be recorded to be presented at a later prior scheduled time, or for such subsequent later times requisite for events. The Archival [470] is shown wherein the non-current and older material may be found to consider for usable storylines. The last item is Interactive [480] wherein sections of any or all storylines may joined up to develop sections to be used to achieve a specific desired objective in the storylines that best answer the requirements set forth in the issues introduced by the client.

In the final section of the chart the acceptance by all concerned in trying to assemble and present a storyline that is satisfactory and is the best available answer to deal and bring out the issues presented by the client. An Authorization [800] is given to accept the choices of the storyline as presented and agreed to by the client who will consent and Affirm [900] the Selection [1000], or if unsatisfactory, the client will not accept, and request a Change [910] whereupon the entire Processes [320] is alerted and activated to begin again in search of a satisfactory and acceptable answer.

In the FIG. 6 the first item at the top is Container File 2 [510] that will open the files of the Alternative Story Development [610] through the normal Processes [320] that receives from time to time an Update [325] when such a need becomes evident herein, and also as an Update [325] as seen and directed to FIG. 7 for its own merit. Processes [320] control and in turn open the subset block of file storage areas when needed. The first to be shown in the inset of this subset block is Live [450] as directed for a live seated audience at the event. Then, it is Real Time [460] wherein the storyline selected would be recorded to be presented at a later prior scheduled time, or for such subsequent later times requisite for events. The Archival [470] is shown wherein non-current and older material may be found to consider for usable storylines. The last item is Interactive [480] wherein sections of any or all storylines may be joined up to develop sections to be used to achieve a specific desired objective in the storylines that best answer the requirements set forth in the issues introduced by the client.

In the final section of the chart the acceptance by all concerned in trying to assemble and present a storyline that is satisfactory and is the best available answer to deal and bring out the issues presented to the client. An Authorization [800] is given to accept the choices of the storyline as presented and agreed to by the client who will consent and Affirm [900] the Selection [1000], or if unsatisfactory, the client will not accept, and request a Change [910] where upon the entire Processes [320] is alerted and activated to begin again in search of a satisfactory and acceptable answer.

### BOX 440 (“Client”)

Description: Those who, in a LRTILE, may interact with Traditional Story Form elements (plot, setting, background and characters), Alternative Story Form elements, Moderators, Actors, Writers, other Participants, Non-Participating Audience Members, Producers, Designers and Inspirational Forces towards the goal of creating, gaining, sharing and expanding awareness, understanding, knowledge, wisdom, truth, and inner, higher, multi- and inter-dimensional consciousness about themselves, others, and the interactive spaces within, between and among, and the universe. Client Participants are comprised of three classes of “interactive engagement”: 1) Direct Participants, those who play a “character” who interacts with other characters, whether played by Direct Participants or Actors; 2) Client coach Participants, those who interact with characters, whether Direct Participants or Actors, and Moderators during freezing of scenes or during Question and Answer sections or during Coaching and Re-coaching sections or during Redo and Revised sections of the Interactive Case Study; 3) Client observer Participants, those whose interactions with characters and moderators are limited to the observation and potential noting and documenting of the varied and holistic interactions within, between and among characters.

All Client Participants have free will in choosing which, if any, of one or more of the three classes of interaction they will perform in. In the event that Participants choose to watch but not interact with the LRTILE, even under the protocols of Client observer Participants, they are defined as “Non-Participating Audience Members”.

Participants may be ‘non-local’ to the LRTILE, yet still a “living interactive presence” in the LRTILE.

Similar the Learning Management System diagrammatic Box numbers 100 through 1000, these Processes & Procedures diagrammatic boxes 2100 through 3000 are numbered with connective lines forming a sequential step-by-step detailed described process and procedure with additional connecting and looping sequences as indicated.

BOX 2100 (“Process for Scripting Story Forms utilized in Live, Real-Time Interactive Learning Events, LRTILEs”)
BOX 2200 (“Activities: Precursor with Multiple Inputs resulting in an original and or adapted Creative Content Story Form”)

Description: One or more combinations of interactive inputs from, between and among Collaborators forming the initial and evolving and ongoing creative ideas, images, graphics, inspirations, and visions for a specific story form script, followed by expanded, nuanced and comprehensive interactive inputs from, between and among collaborators, resulting in original and or adapted Creative Content Story forms, with all inputs being conceived and filtered through an entrainment focus and intention. Collaborators may include the following classes: Writers; Participants; Moderators; Directors; Producers; Actors; Designers; Inspirational Forces (Storyline Insight).

Activities in this Box may be realized through one or more of the following models of Creative Content generation: 1) Traditional Model, wherein Writers are the only class of Collaborators who provide inputs; 2) Community Model, wherein two or more classes of Collaborators provide inputs; 3) Hybrid Model, evident in ‘looping’ hybrids of an Interactive Case Study, as exhibited in contexts where BOX 3000 Utilization of Creative Content Story Forms are generated from mutated, transformed, metamorphosed versions (“altered versions”) of already-existing Interactive Case studies; said “altered versions” are then placed into one or more new BOX 2100 scripting activity contexts, thus resulting in the initiation of one or more cycles of new BOX 2200 activities

### BOX 2300 (“Storyline”)

Description: Within the LRTILE, Storyline writers who are the Originators of any and all creative components explicit and implicit in the Traditional and Alternative Story Forms utilized in the LRTILE.

### BOX 2310 (“Moderators”)

Description: Those who, in a LRTILE, moderate LRTILEs as a mediating, inspiring, guiding and influential force within, between and among Collaborators and the creative and learning components present in Traditional and Alternative Story Forms.

### BOX 2315 (“Directors”)

Description: Those who, in a LRTILE, collaborate with the Writers in realizing the creative vision of the Writers; and who, in manifesting the creative vision of the Writers, guide, support and inspire the Actors (including Direct Participants) in their performances; who collaborate with the Producer in identifying all necessary resources for the production of an effective, impactful LRTILE; who collaborate with Designers in executing the joint vision for the LRTILE as defined by the Writers and Directors; and who may also collaborate with Participants in the process of re-evaluating, redirecting and altering the awareness, consciousness, actions, beliefs and values of the characters.

### BOX 2320 (“Producers”)

Description: Those who, in a LRTILE, collaborate with the Directors, Writers, Designers and Moderators, in identifying, securing and deploying all production resources necessary for delivering an effective, impactful LRTILE; and who also may collaborate with Actors and Moderators in various creative and learning aspects and considerations as relates to rehearsing and performing LRTILEs.

### BOX 2325 (“Actors”)

Description: Those who, in a LRTILE, collaborate with Directors, Writers, Designers, Participants, Moderators and Inspirational Forces in the creation, rehearsal and performance of the Interactive Case Study, including interactive interludes between and among themselves as actors and characters and all other LRTILE Collaborators. Actors may also include “Direct Participants”.

### BOX 2330 (“Designers”)

Description: Those who, in a LRTILE, design, build, deploy, utilize and maintain the design deliverables of the LRTILE, as defined in their collaboration with the Writers, Directors, Actors, Producers and Inspirational Forces. Designers' creative domains include: Sound and Music; Lighting; Costume; Set; Stage; Studio; Production; Audience Spaces; LMS; Interactivity (within, between and among design domains); Graphic; Visual; Recording; Editing; Photography; Properties; Scene; Broadcast and Transmission of Live Real-Time Interactive Learning Event Creative Content; Creative; Conceptual; Themes; Holograms; Ideography and Thought Forms; Chromatic; Geometries of Space and Time; Special Effects; Metamorphoses; Linear, Omni-linear, Non-linear, Sidestream Plot arrangements of Story Forms; Visioning, Representation, Manipulation and Coding of Crystalline and Multi- and Inter-Dimensional Time, Space and Consciousness sets; and in all combinations.

### BOX 2335 (“Storyline Insight by Inspirational Forces”)

Description: The Storyline Insight as perceived and understood through Inspirational Forces, whom, in a LRTILE, may positively inspire, guide, and support all LRTILE collaborators.

PLEASE NOTE: The functions, roles, responsibilities and creative and learning contributions between and among LRTILE collaborators may, at times, be interchangeable.

### BOX 2400 (“Plot”)

Description: In a LRTILE, a combination of the following story elements: 1) characters; their beliefs, feelings, thoughts, values, wants, truths, needs, hopes, fears, sorrows, confusions, guilts, dreams, mysteries, enigmas, and all states and levels of consciousness, awareness and being, and all actions initiated, suppressed, repressed, denied, altered, transformed, accepted, integrated, judged, dismissed within themselves and between and among other characters, and all transformations and re-actions initiated, suppressed, repressed, denied, altered, transformed, accepted, integrated, judged, dismissed within themselves and between and among characters, and in all combinations; resulting in entangled, evolving, dynamic, metamorphosing, revealing, mysterious and ultimately resolving interactions (at some shared level of understanding) within, between and among characters; 2) the details, expansions, shadings and alternate versions of setting, background and character elements that may be introduced by the Storyline, Actors, Client, Participants, Directors, Moderators, Producers and Storyline Insight by Inspirational Forces; 3) story form movement and evolution of characters' actions, re-actions and transformations through various time, space and consciousness sets in the linear “beginning>middle>end” model of Traditional Story Forms; story form movement and evolution may also exhibit “Alternative Story Form” models, like non-linear, omni-linear or “sidestream” models, which may also be characterized by interfacing, evolving and mutating dynamics with, to and from other Story Form movement and evolution models.

### BOX 2405 (“Setting”)

Description: the places, times, eras and cultural milieus of the Interactive Case Study.

### BOX 2410 (“Background”)

Description: pertinent story information, explicitly and implicitly presented, giving depth, breadth, expansion and sometimes alternate versions of plot and setting elements of the Interactive Case Study.

### BOX 2415 (“Traditional Story Forms”)

Description: setting, background and plot elements of the Interactive Case Study.

### BOX 2420 (“Alternative Story Forms”)

Description: In a LRTILE, story forms that may utilize coded, evocative, inductive, revealed, multi-dimensional, and unique knowledge quantum; and the holistic breadth, depth and height of intentions, approaches, systems, models, awareness, discoveries, meanings, wisdom, truths, consciousness, processes, teachings and learnings as realized in the rich diversity of various mystical traditions, practices and movements; creative components of Alternative Storyline Developments include: signs; signifiers; symbols; glyphs; shapes; hieroglyphs; ideas; archetypes; codes; ciphers; language characters; cybernetics; holograms; crystalline resonances and communications; mandalas; sounds and music; geometries; numbers; astrological and cosmological arrangements, attributes and vibrations; vibrations; frequencies; silence; meditation; prayer; inspiration; dreams; visions; multi- and inter-dimensional consciousness experiences; scriptures; thought forms; chromatic codes, arrangements and resonances; non-traditional images, graphics, sounds, syllables, expressions, meanings, ideas and thought forms; meanings; interpretations; words; syllables; expressions; resonances; philosophies; research; texts; scrolls; story form models; formulas; innovative, unusual, altered, hybrid, reconfigured, reconstituted, transformed, metamorphosed versions and components of Traditional Storyline Development elements; and in all combinations.

### BOX 2500 (“Interactive Case Study #1, ICS”)

Description: In a LRTILE, the scripted story form—traditional or alternative in form—from which the LRTILE is presented, and which, as the LRTILE progresses, becomes a living, interactive experience; and whose creative and learning components may be hybridized, mutated, evolved, expanded, distilled, edited, revised, catalyzed, reconstituted, transformed, and metamorphosed into creative and learning components comprising new Interactive Case Studies and LRTILEs.

BOX 2505 (“Rehearsal, process for rehearsing, performing, and modifying Interactive Case Study, ICS”)

### BOX 2600 (“Production Preparation Activities: Rehearsing, Design and Technical Preparation, Phase 1 of LRTILE”)

Description: Director rehearses Actors (excluding Direct Participants) and works with all applicable design element teams and personnel, with support and guidance from and collaboration with Producers, Writers and Moderators, as needed, to provide input on creative and learning components. Designers create, refine, alter and finalize design elements, then deliver tangible, living, finished and operational versions of all design resources required to support and deliver an effective, impactful LRTILE production: all physical materials; sets; props; costumes; lighting; sound; special effects; images; graphics; recording elements; equipment; processes; approaches; systems; models; performance and audience spaces; plans; protocols; devices; machinery; technical, operational and creative interfaces; computer software & hardware; media resources; training of all LRTILE collaborators and their respective personnel, as necessary, on the installation, testing, use and maintenance of all design resources and deliverables. Inspirational Forces are invoked and or transmit creative and learning ideas, images, thought forms and other creative and learning inputs to support the enlivening of the Interactive Case Study.

### BOX 2700 (“Dress Rehearsal Activities: Live Performance, Recording and Archiving of Interactive Case Study, Phase 2 of LRTILE”)

Description: The Interactive Case Study is performed and realized in a live setting, with audiences present in a local and or non-local (broadcast-streaming-satellite-etc) orientation.

NOTE: The activities of Boxes 2700 above and 2800 below are, potentially, BOTH separate and contiguous.
BOX 2800 (“Live Performance Activities: Live Creation, Performance, Recording and Archiving of Unscripted and Revised, Expanded and Transformed Scenes, Characters, Background, Setting, Plot, Story Forms, Learning and Consciousness Elements dynamically related to the Interactive Case Study, Phase 3 of LRTILE”)

Description: At certain points in the Interactive Case Study, Collaborators, as “living presences”, may penetrate the hermetic world of the case study, transcending the limited, isolated experiential bounds explicit and implicit in that world. Specifically, these “creative and learning experiential interactions” between and among LRTILE Collaborators manifest in the following live, real-time interactions: 1) Question and Answer sections between and among LRTILE Collaborators (EXCEPT Observer Participants); 2) Sections where LRTILE Collaborators may “FREEZE” the Interactive Case Study, with the goal to expand self-awareness, social awareness, interactive awareness and other types, levels and combinations of insight, truth, knowledge awareness and wisdom, including the productive application of Learning and Story Form elements in all aspects of living; 3) Learning Content and Debrief Sections, in which LRTILE Collaborators present, discuss and evaluate learning components of various human, spiritual, scientific, aesthetic, practical and experiential systems, models, approaches, paradigms, approaches, philosophies, codes, standards and dynamics present in the LRTILE; the evaluative findings generated by LRTILE Collaborators may be applied to any of the “creative and learning experiential interactions”; 4) Sections where Direct Participants choose to be Characters in the LRTILE who interact with other LRTILE Collaborators in the presentation of Revised, Expanded or Transformed Scenes (related to the Interactive Case Study); 5) Coaching and Re-Coaching of Characters during and after the original performance of the Interactive Case Study, and also, subsequently, during the Revised, Expanded or Transformed scenes envisioned and selected by LRTILE Collaborators; 6) Sections where Discussions, Evaluations, Assessments and Ratings are conducted concerning the various learning modalities, models, systems, approaches, philosophies, paradigms, standards, practices, codes and all forms, types and kinds of learning definition, assessment and evaluation utilized in the LRTILE; 7) Synergistic, parallel and evolving cross-pollination process of generation of creative and learning component content for the future design, development and delivery of new interactive case study outlines as LRTILE productions that may be disseminated within, between and among various creative and learning content delivery platforms.

NOTE: The live performance of the Interactive Case Study may occur in a theater, studio, concert or music hall, auditorium, religious or spiritual space, or any performance space or venue which allows for a live performance process, and which interfaces with production resources allowing for the broadcast, transmission, streaming and other types of creative and learning content dissemination which can support interactive production capabilities, whether the Interactive Case Study is in live, delayed or recorded states.

BOX 2900 (“Production Review Activities: Review, Editing, Modification, Archiving and Dissemination of all Phases, BOX 2800 content of the LRTILE, Phase 4 of LRTILE”) including evaluating the potential creative and learning values present in that content.

BOX 2910 (“Editing after Review BOX 2900 Content of LRTILE”)

Description: This process includes not only normative editing goals, tasks and processes, but the insertion of additional creative and learning content, which may expand, limit and transform the creative and learning content of the original Interactive Case Study and allows and provides creative and learning content from which new Interactive Case Studies and LRTILEs can be designed, developed and delivered. The creative and learning content herein is comprised of four potential kinds of Interactive Case Study and LRTILE content (that may, also, be intermingled): 1) content autonomous from and independent of a previously produced LRTILE; 2) content autonomous from and independent of a LRTILE currently in phases of development or production; 3) content in part inspired by and created from a previous LRTILE; 4) content in part inspired by and created from a LRTILE that was previously produced; 5) content currently in development or production. After this process of editing is completed, Phase 4 BOX 2900 LRTILE content has been officially documented and created.

BOX 2915 (“Archiving of all Phases BOX 2900 Content of LRTILE”) including any post editing Box 2910

Description: This process involves not only Archiving of the all Phases BOX 2910 LRTILE Content, but archiving said content in a manner allowing for the most efficient, robust, flexible, mutable, evolvingly innovative and multi-purposed security, storage, management, retrieval, re-editing, modification and dissemination capabilities related to said content.

### BOX 2920 (“Dissemination of all Phases of Content of LRTILE”)

Description: This process involves dissemination through various modalities of information transfer, including broadcast, transmission and streaming modes. The Dissemination of all Phases BOX 2910 Editing LRTILE Content may include dissemination to beings in public, private, terrestrial, extra-terrestrial, and interfaced multi- and inter-dimensional consciousness times and spaces.

BOX 3000: (“Interactive Modification and Utilization of Existent LRTILE Content in process of creating new LRTILE Content”)

Description: In this process, existent LRTILE Creative and Learning Content may be “interactively interfaced” (mutated, transformed, expanded, revised, metamorphosed, hybridized, reconstituted and altered) within, between and among all tasks, functions, processes, outcomes and creative and learning content goals, inputs, and deliverables, as desired by the LRTILE Collaborators, including interactive interfaces with any and all previous, current or yet-to-be-designed LRTILEs, in whatever phase and sub-phase activities, with all inputs being conceived and filtered through an entrainment focus and intention, towards the goal of generating new creative and learning content for future LRTILEs.

Thus, activities in BOX 3000 may loop back to the activities of BOX 2100 and any other Boxes of activity as described in FIGS. 7 and 12 including the following utilizations:
1) Existent LRTILE (previously produced or currently in development or production) creative and learning content, including Interactive Case Studies, may be utilized in a new, transformed manner
2) Said utilization is characterized by the altering, reconstituting, transforming, mutating, hybridizing, metamorphosing (“changes”) of one or more creative and learning content components of an existent LRTILE (or existent LRTILEs) intermingled with the learning and creative content components of one or more of the following: 1) another existent LRTILE; 2) LRTILEs envisioned for future development and production; 3) existent and evolving creative and learning content components present in mystical, wisdom, philosophical, scientific, religious, aesthetic, spiritual, artistic, creative beliefs, values, traditions, movements, practices, theory and models.
3) Said utilizations may thus generate new LRTILE creative and learning content that, although using some quantum of already-created LRTILE creative and learning content, may be defined as independent and autonomous from the already-created LRTILE content, as defined by the standards of intellectual property rights and protections of said utilizations.
4) Said utilizations may generate new LRTILE creative and learning content complementary to previously produced or currently being developed and produced LRTILE creative and learning content. The new LRTILE creative and learning content described in this clause may involve the redesign of a previously produced or currently being developed or produced LRTILE.
5) Said utilizations may involve design, development and delivery processes which are comprised of new, previous or new and previous creative learning content generated by LRTILE collaborators.
6) Said utilizations may involve the initiation and execution of new BOX 2100, BOX 2500, and BOX 3000 processes, which, may involve using fewer or different Box Collaborators or learning Activities than those used in previously produced or currently being developed or produced LRTILEs.

### BOX 4000: (“Client and Sponsor Review”)

1) Description: In this process, the Client and Sponsor are engaged to review and advise of the Utilization efforts of Box 3000 and possibly recommend archival activities and dissemination activities as the preferred final disposition of the Interactive Event content.

### SUMMARY OF THE INVENTION

This invention relates to a system of processes and procedures that are organized within a framework that exemplifies a management system for learning and understanding. Unlike a traditional ‘Learning Management System’ that manage content, access, and distribution, this invention describes a framework that includes content creation with varied traditional and alternative storyline themes that can be interrupted and adjusted to focus upon client issues. Also, the selection and insertion of varied storyline endings following a ‘Point of Decision’ that will focus the discovery of cultural identifying subject matter to assuage, abet, and aid the issues of the client. Participants are pre-selected upon testing, assessment, and evaluation whereby their open mind, command of data, and satisfactory ability with decision making will affirm their interest to be supportive of the issues of the client and alignment to strategic company goals. The requirement of a moderator who is to be retained for the management of arranged group events with pre-selected participants, the actors that will portray the selected plot with characters, and the training, interactions, coaching, re-coaching, final selection of one best storyline by the voice acclamation of all pre-selected participants. The moderator will oversee the point of decision wherein any of the plots reviewed will undergo their own evaluation to seek a one best storyline to the situation at hand in the clients interest. Of the few plots accepted for such further review, all will be subject to an update to gather all salient points, scripting changes interweaving selected storylines with alternative endings if required, plus verification of actors available, supervisory personnel, staff to handle activities, all storylines that are needed, and all to be required of the moderator as the storyline proceeds.

The prior activities described under the direction of the moderator will encompass the first seven Figures provided with this invention in this application. The arranged grouped event may be built upon these activities especially if for a limited small live audience, if that is all that the client may desire. However, in the final FIG. 8 through FIG. 11, there will be shown the complexity and effort for an event with a larger audience, or a later time event to be recorded for a scheduled performance at a later time, or for presentation of a number of times and different locations. What is unique here is that small or large, these storylines are interactive, interspersed, and interrupted to improve and focus on a target issue brought by a client for its performance. Oftentimes in a wider range of presentation of these storylines and plots that are designed to be interrupted, and to change, or adjust, or re-focus, typically at the point of decision. This action will open up and respond to a new update, or approach to issues, to benefit the client. In these larger scope activities, or with continued issues, or changes for an event, when set and agreed to, such are termed “Live Real-Time Interactive Learning Event” [by acronym, LRTILE].

From FIG. 8 through FIG. 11, the range of staff and personnel will be increased to meet the increased demands, and changes that benefit the client's issues, there will be a requirement to retain and hire a ‘Director’ to oversee all activities of an arranged grouped event. As all of these tasks to produce the one best storyline to benefit the issues of the client, the Director will seek, retain and hire a ‘Producer’ to accomplish all of what is needed to put on the show at an event. This Producer will assemble and instruct the actors on their character portrayals, and retain a ‘Designer’ to implement the requirements of the stage and scenes to the satisfaction of all concerned. As all of these activities begin to come together, the storyline insights will be sought to perfect the performance with the most complete presentation that is possible.

Another review of the intended presentation will be shown in FIG. 9 following wherein the plot will be updated to be current, and the Producer and the Designer will join together to review the Setting and the Background of the storyline in its proper and best form. Any further review as requisite of the ‘Traditional Narrative Story Forms’ or for inclusion, if required in whole or in part, and with variations of storyline endings to review the ‘Alternative Narrative Story Forms’ to ascertain that the one best storyline is ready to produce.

As FIG. 10 opens with a ‘Case Study’ of all variations of stories and endings under the view of the Director with the Producer and the Designer and likely with some of the Actors seeking the final approval of the one best storyline as affirmed by the client for the arranged grouped event. Any Updates considered are herein moved back and forth to interact with the storylines as such are being perfected. Once the one best storyline has been reviewed and established, it will pass into a Rehearsal to see if there are any defects or improvements that need to be considered. After a successful Rehearsal, this one best storyline will move into ‘Production Preparation’ which precedes a full ‘Dress Rehearsal’, and that in turn if successful, will pass into the final ‘Live Performance’

It would be the expectation of a stellar performance before the live audience, and as such, it would be recorded in its total performance to be retained for other later performances direct to classes, events, remote locations, even via television or computer as the client may prefer or arrange. The original live audience performance would pass into a ‘Production Review’ and ‘Editing’ for any adjustments required to fit into limited times, selected emphasis in part, focus on selected details or issues, and other requirements as such occur. When adjustments are needed or enhancements are sought, the procedures of ‘Utilization’ would activate such, back and forth, or place these edited versions into ‘Archive’ back and forth, available from ‘Dissemination’ for future adaptive uses or future demands for use. In the mode of ‘Utilization’ the versions in its command would also be available to ‘Client and Sponsor Review’ for any and all needs that the issues of the client might require.

These Figures as presented herein are from the first opening of issues of the client in FIG. 1 through FIG. 4 wherein the ‘Learning Management System’ operates through ‘Content Management’ and ‘Operatives’. The FIG. 5 through FIG. 7 represents the search process through resources of files for better storylines in Traditional and Alternative Stories to locate and accept or reject the examples found. In the FIG. 7, with the better examples and possibly story endings all such are formalized with introspection of scripts to improve, activities to produce and involve actors, find selected storylines, all to be placed with a Moderator that will introduce these additions to staff, pre-selected participants, and actors as the best to get started with. With the FIG. 8 through FIG. 11, the many updates, plots, case studies and details necessary are presented with finally the production being shown to an audience. In FIG. 11, the final editing and utilization takes place for storage until needed again.

In this patent in application, the opening claim aptly describes the process and delineates the methods in the very first claim. The authorization and content control remains in the client's domain wherein all subsequent activities remain in the control and selection as overseen by the client, and the organization for the event that unfolds is dictated by the client. As it is stated in the opening detail of claim number one, it says: “the storyline is of interest” [to the client of course], and then, “actors will portray characters in said storyline” [actors are paid by the client to do as dictated]. There follows, “a point of decision in the storyline” wherein as the story is developed, the variations for different alternative endings can be foreseen. Then, “a moderator may interrupt said storyline” at multiple points to offer the several choices that might logically follow. Then it can be seen, “participants discuss storyline developments” in part to understand what other versions might be undertaken to achieve more vibrant endings even more meaningful and impactful to the issues of the client. To continue, “participants shall interact with moderator” and said moderator is hired by the client to work through the best applications, elements, issues, and subjects being considered. Said moderator also conducts, “discussions with actors portraying characters”.

The client concerns also include, “discussions with actors portraying characters by participants”. Further comprising is that a, “coaching session with actors portraying characters by moderator”, is achieved. To continue, there is held a, “coaching session with actors portraying characters by participants”. On some occasions new issues arise, and, “re-coaching sessions between actors portraying characters by moderator” are held.

A further assemblage is held with, “re-coaching sessions between actors portraying characters by participants” are completed. Then, “participants shall interact with storyline being developed by characters portrayed by actors”. Then, as continuing with discussion, “participants shall interact with actors portraying characters interacting with moderator”. Then, “moderator summarizes several choices for storyline plot development”. Wherein, “participants acclaim by voice vote one best choice of storyline plot development”. And, finally, “actors will portray final storyline plot development selection”.

In a summary of this long and encompassing initial claim, it is shown herein as written to follow. “An interactive participant choice of final plot development comprising essentially of these following items:
a. a storyline of interest;
b. actors will portray characters in said storyline;
c. a point of decision in the storyline;
d. a moderator will interrupt said storyline;
e. participants discuss storyline development;
f. moderator shall interact with actors;
g. participants shall interact with moderator;
h. participants shall interact with actors;
i participants shall interact with storyline being developed by characters portrayed by actors;
j. participants shall interact with actors portraying characters interacting with moderator;
k. moderator will summarize several choices;
l. discussion between actors portraying characters by moderator;
m. discussion between actors portraying characters by participants;
n. coaching session between portraying characters by moderator;
o. coaching session between actors portraying characters by participants;
p. re-coaching session between actors portraying characters by moderator;
q. re-coaching session between actors portraying characters by participants;
r. participants acclaim by voice vote one best choice of storyline development; &
s. actors will portray final storyline development selection.

In addition thereto the FIG. 1 through FIG. 11 following give further detail and explain all aspects of this patent in application. In the FIG. 1 the outline graphically shows that the ‘Learning Management System’ details: Location, Content and Testing. This opens up these relevant issues in this first claim. Then FIG. 2 shows ‘Content’ leading to ‘Content Management’ that allows traditional and alternative story development. The FIG. 3 further allows ‘Content Management’ leading to ‘Operatives’ to interact to open discussion and to portray a traditional storyline selection through the point of decision wherein alternative storyline endings are to be considered. The potential choices would have been already discussed by the pre-selected client team with a moderator with a single best choice voted on to portray. The participants in discussion with the actors offer their one best choice for consideration and affirmation by client. Wherein if not accepted and authorized by client, then the FIG. 4 through ‘Change Control’ mode will enact an ‘Alternative Story Development’ with its ‘Alternative Endings’ to be affirmed by client and authorized.

In FIG. 5 an example of a traditional storyline is put through its development, and—if affirmed by client—moves ahead into its final form to be produced. Then, after its development, if FIG. 5 does not receive its ‘Authorization’ that can lead to approval by said client to be accepted as an ‘Affirm’ to be produced as the final ‘Selection’. Then, this traditional storyline will be returned, through a ‘Change’ mode to ‘Processes’, to begin again. As shown in the FIG. 6 an alternative storyline is to be selected, to undergo its development for its consideration and its selection. The complete operation for this patent in application is thus shown graphically in these first 6 Figures herein attached.

Once again, as this claim number one sums up the entire operation of this patent in application, and it is to be stated in part to follow. To summarize this entire operation of this patent in application, it is exquisitely detailed to follow in claim 1 as a complete operation of this patent: [No. 1 states] ‘An interactive participant choice of final plot development comprising essentially of these following items: [a] a storyline of interest; [b] actors will portray characters in said storyline; [c] a point of decision in said storyline; [d] a moderator will interrupt said storyline; [e] participants discuss storyline development; [f] moderator shall interact with actors; [g] participants shall interact with moderator; [h] participants shall interact with actors; [i] participants shall interact with storyline being developed by characters portrayed by actors; [j]participants shall interact actors portraying characters interacting with moderator; [k] moderator will summarize several choices; [l] discussion between actors portraying characters by moderator; [m] discussion with actors portraying characters by participants; [n] coaching session between actors portraying characters by moderator; [o] coaching session between actors portraying characters by participants; [p] re-coaching session between actors portraying characters by moderator; [q] re-coaching session of actors portraying characters by participants; [r] participants acclaim by voice one best choice of storyline development; & [s] actors will portray final storyline development selection.

In the initial stages of management with all concerned, when the pre-selection has been completed and participants are to be engaged, it is evident that discussions to align the client's issues and solutions with participants understanding and acceptance of such will require facilitation with skilled leadership to accomplish and support the client's goals. In this occasion as seen in claim 2, the choice of the final plot development will be further comprising that the storyline will introduce a point of decision wherein choices of a new final ending are to be evident to the participants. The discussion and interaction with such related issues and the material of the client will be placed with a moderator hired to perform these tasks and to help the participants and actors and staff better understand these issues. There are many choices that will have to be sifted through each time, and a focus to be identified, understood, and achieved in order to accomplish the purposes established by the client and to be able to continue with this undertaking. It is in FIG. 1 that such efforts are stated in Learning Management System to pre-select the participants that are able to develop and demonstrate such skills and abilities requisite for the client's interests as herein shown in this patent in application. In the claim 3, the choice of final plot development further comprising said moderator will interact with actors.

These pre-selected participants will have shown abilities to make decisions and interact in discussions and to be able to select several acceptable storylines and endings that the participants will have to choose from. In order to accomplish such a task, some coordination and overall agreement would likely require coaching on how to develop these skills as listed in claim 1 [n], 1 [o], 1 [p], & 1 [q] that would all seek to upgrade their comprehension and skills in such issues. Following these discussions, the moderator will open re-coaching sessions with the actors, the participants, and all concerned to help with the understanding of the issues at hand and with the best means to present solutions acceptable to all parties concerned.

The moderator will open coaching sessions with the actors portraying the characters in the manner selected. The moderator and participants will continue in their coaching and re-coaching sessions to understand their issues to be considered. Re-coaching will continue between actors that portray the characters in the best view when selected for a best storyline that is chosen. After these sessions the moderator and the participants; will provide input from all concerned including the client, will summarize the several best scenarios and, will by voice vote acclamation from the participants choose the one best storyline to present to the arranged grouped event.

Following the claim 1 that details all of the steps to achieve the one best storyline for production for a client, it seems that reinforcing the operations as described that claim 2 does begin the steps as required. The choice of best selected plot development with its storyline in claim 2 introduces the point of decision wherein it seems that the story has approached at point wherein these endings may be selected to form a different result and the choices of a final plot ending are to be evident to the participants. The choice of final plot development further comprising said storyline introduces a point of decision wherein choices of a new final ending are to be evident to participants.

In claim 3 to follow it is stated that the choice of selected plot development further comprises that the moderator will open discussion with actors about the portrayal of the story characters. The choice of final plot development further comprising said moderator will interact with actors.

Additionally, as in claim 4, the said actors will open discussion with the participants. In this claim, the choice of final plot development is further comprising that said actors will open discussion with said participants.

The purpose for all such interaction and open knowledge for the best choices of material that can suit the issues of the client and that it will be brought forth for all concerned to have an understanding of all of the over-riding factors at hand and a single one best choice could be made.

In the following claim 5 it is stated that the choice of final plot development is further comprising that said moderator will open discussion with said participants. Accordingly, in the following claim 6 also, it is stated that the choice of final plot development is further comprising that said moderator will summarize several best scenarios offered by said participants. Then, in the next claim 7 it is the choice of final plot development that is further comprising said participants will acclaim by voice one best choice for new final plot of storyline. It would then be the support and obligation in claim 8 that the choice would be further comprising that actors, portraying the storyline throughout, shall present said new final plot as chosen.

Next in sequence is claim 9 wherein the: “Interactive participant choice in arranged grouped events shall comprise that said events comprise participants with essentially as such may be, singly, and in combinations, but not limited to, these stated purposes: [a] educational; [b] teaching; [c] informational; [d] commercial; [e[corporate; [f] government; [g] military; [h] community; [i] to interact with discussion; [j] to learn evaluation; [k] to experience decision making; [l] to select choices; [m] to collaborate in an interactive learning experience; [n] to gain knowledge of self; & [o] to gain knowledge of others.

Continuing with this open discussion in claim 10 the said participants in said event will further comprise that the moderator be available to open discussion with said participants at point of decision in storyline at said event. Following the opening of interactive discussion, it is stated that the said participants in said event as stated in claim 11 are further comprising that at the point of decision in said storyline that several, if not many, choices of the new final ending of said storyline be discussed with said participants. Where upon it is stated in the following claim 12 that the said participants in said event are further comprising that said participants will acclaim by voice vote the one best selection for said new final ending.

Further, an independent claim 13 immediately following states: “An arranged grouped event shall comprise pre-selective interactive participants, and all concerned, will essentially require singly, and in combinations, but not limited to these following items: [a] a normal classroom size; [b] be of any size larger; [c] to extend to additional locations; [d] to be connectable by voice means; [e] to be connectable by visual means; [f] to be scattered in locations; [g] to be scattered yet connectable for content; [h] to be pre-selected for a specific issue; [i] to gather participants for s specific issue; [j] to gather participants for an interactive learning experience; [k] assemble participants for education on a topic; [l] assemble for commercial interests; [m] assemble for private reasons; [n] assemble for public reasons; [o] assemble for a corporate requirement; & [p] assemble for any legal reasons.

In the following dependent claims, the first is claim 14 wherein the said event will further comprise said interactive participants as pre-selected by the client and sponsors will be adaptable and informed of issues under consideration for said event. Following next, is claim 15 wherein the said event will further comprise said interactive participants being pre-selected by the client and sponsors will possess qualifications and skills requisite to manage with conditions upcoming in the event. Then, to follow in claim 16, the said event will further comprise said interactive participants being pre-selected by the client and sponsors will be chosen to evidence an open mind to be unprejudiced of issues being considered by client and sponsors. Another following dependent claim 17 states “The said event of claim 16 further comprising said interactive participants as pre-selected by client and sponsors be presented by said moderator with several choices in summary to consider. In the final dependent claim 18 it is stated: ‘The said event of claim 17 further comprising said interactive participants shall by voice vote acclaim one best selection for the new final ending.

Interactive participants in the arranged grouped events in a following independent claim 19 will comprise a pre-selected group of persons knowledgeable and informed of issues to discuss through efforts of a moderator that conducts said event. Further in a following dependent claim 20, it states, the said interactive participants in said arranged grouped event of claim 19 further comprises that said event has sponsorship with the client and sponsors are well qualified in their field and they desire the best choice in a pre-selected storyline in its new final ending. Then, it follows in the next dependent claim 21, the said interactive participants in said arranged grouped event of claim 20 further comprise that some of the pre-selected participants have been interviewed wherein their qualifications and skills are accepted and pre-selected by said client and sponsors. Then, in claim 22, the said interactive participants in said event of claim 19 further comprising that said interactive participants being those pre-selected by client and sponsors are chosen to be individuals with experience and knowledge of said issues being considered by client and sponsors. Following in the dependent claims is claim 23 wherein it is said, the said interactive participants in said event of claim 19 further comprising that those pre-selected that are chosen will have good communication skills with an open balanced mind of said issues being considered by client and sponsors. In claim 24 it is said that the said interactive participants in said event of claim 23 further comprise being pre-selected by said clients and sponsors are adjudged competent to interact with said moderator on all choices that arise out of said event. In the claim 25 to follow, it is said that the said interactive participants in said event of claim 24 further comprising said pre-selected participants affirmed by client and sponsors will be chosen to have a commitment to improve the issues being considered by said client and sponsors. In the next dependent claim 26 it is said, the said interactive participants in said event of claim 19 further comprising that those pre-selected are chosen to have the courage to speak the truth in an unbiased manner to the issues at hand, and not their personal view of the truth. In the final dependent claim 27, it is stated, the said interactive participants in said event of claim 19 further comprising that those pre-selected are chosen to have the sensitivity to absorb mutually defined goals of dramatic and cultural issues at hand that affect the client and sponsors.

As it has been seen in the prior going set of claims that all considerations would be directed to help the client and sponsors that contracts the said event to help with the issues at hand that can also involve the similar issues of a sponsor that can join in seeking support and best means of resolving such issues. It is seen that the participants will be tested, and assessed for their competence, skills and interest in resolving in the best manner the issues of the client and the client's sponsors to upgrade their awareness and try to bring about a solid and satisfactory compromise equitable to all parties concerned. The best candidates for interactive participants will be affirmed by the client and sponsors, and be retained to help guide a best possible solution to the issues facing the client and sponsors. These interactive participants will be chosen to have a commitment to improve the issues at hand being considered by the client and sponsors. The client and sponsors may offer interactive case studies to assess different facets of issues facing the client and sponsors. These participants as affirmed by the client and sponsors will be adjudged competent to interact with the moderator on all choices that arise out of the arranged grouped event. These interactive participants will review all of the issues with the moderator in order to select relevant examples from traditional and alternative storylines that may suit their needs, and with alternative endings, as best suit the issues of the client and sponsors. These participants have been pre-selected by the client and sponsors for their competence and skills to discuss and evaluate with their interceding moderator to reach the best of selections and processes to make all of these undertaking perform to clients and sponsor's satisfaction.

In the independent claim 28 that follows, it is said, arranged grouped events comprise training utilizing interactive case studies wherein a client and sponsor seeks to assess their cultural identity by the means of issues highlighted in the training experience. These case studies are detailed in FIG. 10 where upon the Case Study progresses from FIG. 9 with its storyline emerges from Plot, and its Setting and Background, that lead through the Traditional Narrative Story Forms and into the Alternative Narrative Story Forms in the effort to originate and construct from these sources the requisite storyline to be used as the one best storyline for the client and sponsor. These stories will then be passed into FIG. 10 into an opening Case Study wherein back and forth will pass to the Updates in an effort to improve several commendable storylines to be acclaimed by voice vote as the one best storyline to be used. Then, after a final choice of one best storyline with a final selected ending, such a choice will proceed into Rehearsal and then Production Preparation and into a Dress Rehearsal for the final effort in the Live Performance. It would be this Case Study that puts all of the choices and sections into a cohesive final one best storyline for the client and sponsor. In the FIG. 11 that ends the drawings for Figures herein submitted, all of the procedures and selections are set into Utilization for the client and sponsor to review and back and forth into the Archive and back and forth into Dissemination for such uses as in the future may be required.

In the following dependent claim 29 it is stated, the arranged grouped event of claim 28 further comprising said case study model that involve pre-selected interactive participants yield scenarios from its grouped effort that convey cultural truths. The next and final dependent claim 30 states, the arranged grouped event of claim 29 further comprising said pre-selected participants will yield best practices as affirmed in the client and sponsors business model.

In the following independent claim 31 it states, a Learning Management System comprising client and sponsor support in an arranged grouped event wherein issues of client and sponsor may be reviewed to be processed as case studies through these elements
a. location;
b. content; &
c. testing.

From this independent claim 31 above herein follows the dependent claim 32 that will continue dependent until final claim 42 that completes this section of claims of this patent in application. This activity of the Learning Management System is shown in FIG. 1 through FIG. 4 in diagrammatic charts wherein visual confirmation can be achieved of how this system operates. In this next immediate claim 32 it states, the learning management system of claim 31 further comprising that the locations are to be a size with services suitable for said event. Of a further description in the following claim 33 it states, the learning management system of claim 32 further comprise said locations can provide services capable for remote locations.

Then, in claim 34 it was said, the learning management system of claim 31 further comprising said content may be presented in traditional story form. Then into claim 35, it says, the learning management system of claim 34 further comprising said content can accommodate alternative story endings requiring alternative story development. In the next dependent claim 36, it says, the learning management system of claim 31 further comprising said testing can provide measurable participants understanding with issues satisfactory to clients and sponsors. In claim 37, it is said, the learning management system of claim 31 further comprising said testing can provide participant assessment for client and sponsor evaluation to pre-select participants for arranged grouped events.

In the next independent claim section with claim 38, it is said, a learning management system comprises content management with change control to activate any and all files as requisite for the arranged grouped event. In a following dependent claim 39, it is stated, the said learning management system of claim 38 further comprising said change control can maintain versioning and select files as requested by moderator operative. In claim 40, it says, the learning management system of claim 39 further comprising said moderator operative engage pre-selected interactive participants to discuss any storyline developments authorized by client and sponsor. In the following dependent claim 41, it states, the learning management system of claim 40 further comprising said pre-selected interactive participants following discussion acclaim by voice vote the one best choice for said storyline. Then, the final dependent claim 42, states, the said learning management system of claim 41 further comprising said moderator operative interact with actors that portray characters performing said one best choice as authorized by client and sponsor for presentation to said arranged grouped event.

The utilization of this non-traditional Learning Management System provides a framework for both Traditional Story Development, and Alternative Story Development, to coexist and yet allow each to be original in creation. This procedure will also allow and enable modification to occur that provides different storyline endings to unfold in order to produce the very best approach to resolve many of the client and sponsors issues at hand.

This invention relates to storytelling with actors portraying characters and an audience prepared to choose the final storyline outcome by acclamation. A moderator interrupts the storyline points of decision to open a discussion with the audiences for the choices to be considered, and the moderator will select one of the several possible choices from the acclamation of the audience. The final choice will then proceed with the cast of actors to perform the storyline selected.

This patent in application engages procedures to interview and pre-select participants from the client's requirements wherein all said pre-selected participants are prior approved by the client. The elements and issues and the narrative storyline are to be outlined to these pre-selected participants for their consideration and understanding before and during the actual Interactive Event. These participants can then be assembled into an arranged grouped event wherein the choices of a best final plot ending will be discussed and chosen by a vote with voice acclamation and affirmed by the client and sponsor.

The Traditional Storyline Development narratives and the Alternative Storyline Development narratives enable the “arranged group events” learning session to manifest into an Interactive Event, wherein the creative content of a Case Study becomes a Live, Real-Time, Interactive Learning Event with creative content within a Learning Management System Framework.

Furthermore, the live state of the Storyline presentation of the Event is evident by the live reception of the storyline content by the participants. In addition to this live state of the event, is the perception of measurable [, elapsed, physical,] linear time that parallels a real tangible shift in individual and collective group consciousness referred to as the [Real-Time awareness] within the Interactive Event.

The Interactive Event further exemplifies its unique and novel approach to Storyline modifications via the utilization of a Live Real-Time Interactive Event Moderator (LRTILEM) who performs actions defined herein including that of a Change Agent effecting said actions within a Change Management process. Another Moderator action includes monitoring the procession of content creation by the Operatives comprised of; the Participants, the Actors, the Moderator, and the Client. These Operatives may be combined with Inspirational Forces to positively influence the Interactive Event elements and components within the entirety of the Interactive Case Study. Another Moderator action includes monitoring the interaction among Interactive Event collaborators that allows for management of Key Control Points as “points of decision” of the Storyline and its progression through alternative Storyline endings.

The Interactive Event continues to engage all participants of the arranged grouped event, wherein the audience, referred to as; Live, Real-Time Interactive Learning Event Audience (LRTILEA), including ‘evaluative’ How? What? When? Criteria? toolsets through assessment and feedback identified as an Interactive Learning Event Assessment (ILEA), which informs and provides evidentiary based conclusions of participants' Storyline understanding.

High quality Storyline and learning content creation may require iterative production by process design, identified herein; engaging different versions with possible input from sources, and evolving into an interactive creative content experience that can shift among timelines including; live, real-time, non-linear, and such, into a perceived consciousness timeline for a complete presentation to all participants, no matter their location, all inclusive of an interactive Moderator controlled process of presentation.

Additional advantages of this invention will become evident to those skilled in the art from the detailed description herein; this includes an embodiment of this invention by way of both illustration in Figures and description of the invention narratively. This invention may be realized and capable of other and different embodiments with modifications in respects all without departing from this invention. This invention may be practiced without some of the specific details described herein, and may be a functional Learning Management System, simplified in the process of minimalization yet remain operationally complete. In other embodiments, defined processes and procedures known in existing art, or may have not been described herein, in order to not obscure this invention. Accordingly, the description and associated drawings are to be recognized as illustrative in nature, and not as restrictive.

The essence of this patent in application is that of a Learning Management System with control mechanisms that interactively engage structured and improvisational content-based storytelling techniques with responsive participants in-situ and in grouped audiences within a live, real-time, interactive, learning event with an arranged group performance as selected by acclamation of a chosen plot developed storyline, organized as a sequential interactive event, including processes and procedures for selection, review, updating and change management, with approvals by a Client and Sponsor styled affirmation and control methodology.

### BRIEF DESCRIPTION OF DRAWINGS

The disclosed embodiment illustrations represent features and functions in association with this detailed description that are more clearly identified in these drawings. A brief introduction to the illustration Figures is below.

FIG. 1 illustrates the diagram for the Learning Management System process including; Learning Management System [100], Location [200], Content [210], Testing [220], Classroom [301], Event [302], Assessment [330], and Evaluation [340].

FIG. 2 illustrates the diagram for the Content process including; Content [210], Content Management [300], Change Control [400], Container File 1 [500], Container File 2 [510], Traditional Story Development [600], and Alternative Story Development [610].

FIG. 3 illustrates the diagram for the Content Management process including; Content Management [300], Operatives [310], Change Control [400], Moderator [410], Participants [420], Actors [430], Client [440], Traditional Storyline Development [600], and Alternative Endings [700].

FIG. 4 illustrates the diagram for the Content Management process including; Content Management [300], Operatives [310], Change Control [400], Moderator [410], Participants [410], Actors [430], Client [440], Alternative Storyline Development [610], and Alternative Endings [710].

FIG. 5 illustrates the diagram for the Container File 1 managing content including; Container File 1 [500], Traditional Story Development [600], Processes [320], Update [325], Live [450], Real Time [460], Archival [470], Interactive [480], Authorization [800], Affirm [900], Change [910], and Box 1000, Selection [1000].

FIG. 6 illustrates the diagram for the Container File 2 managing content including; Container File 1 [500], Alternative Story Development [610], Processes [320], Update [325], Live [450], Real Time [460], Archival [470], Interactive [480], Authorization [800], Affirm [900], Change [910], and Selection [1000].

FIG. 7 illustrates the diagram for the process of storyline scripting including; Update [325], Scripting [2100], Activities [2200], Storyline [2300], and Moderator [2310].

FIG. 8 illustrates the diagram for the process of storyline inputs including; Director [2315], Producer [2320], Actors [2325], Designer [2330], and Storyline Insight [2335], with one or more combinations of interactive inputs.

FIG. 9 illustrates the diagram for the process of Story Forms with one or more combinations of interactive inputs from and among each other including; Plot [2400], Setting [2405], Background [2410], Traditional Narrative Story Forms [2415], and Alternative Narrative Story Forms [2420].

FIG. 10 illustrates the diagram for the process of Production and Performance including; Case Study [2500], Update [325], Rehearsal [2505], Production Preparation [2600], Dress Rehearsal [2700], and Live Performance [2800].

FIG. 11 illustrates the diagram for the process of Review, Editing, Utilization, Client and Sponsor Review, Archiving, and Dissemination including; Production Review [2900], Editing [2910], Utilization [3000], Archive [2915], Dissemination [2920], and Client and Sponsor Review [4000].

### DETAILED DESCRIPTION OF THE DRAWINGS

In these Figures that follow it does seem that the essence of this patent in application can be fully understood and described to exemplify the claims that are shown herein in this invention. The direct action to produce with a live group as it involves the actors that portray the preselected storyline as it was reviewed and selected by the participants and affirmed to the satisfaction of the client as the best embodiment to have presented. Additionally, it seems obvious that for a later presented real time portrayal at a set schedule, possibly even repeated again over time as may be needed to involve wider grouped events and even at remote sites, or as such later needs might request, that all the best selected embodiment by all parties concerned. Even further and extended embodiments can be recorded and presented in later real time situations from the library system of archival storage as shown to follow in these Figures.

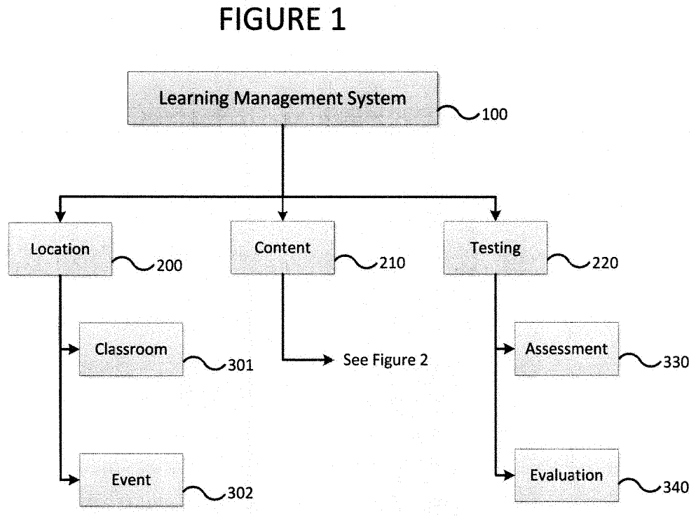

In FIG. 1 there is seen a diagrammatic chart with the command shown and described as Learning Management System [100] that in turn is detailed and does direct where these preselected activities will be held as in a Location [200] that is described below as a Classroom [301] which is intended to accommodate a small arranged group of 10 to 20, or up to 30 in the space of a normal classroom; or to follow an Event [302] wherein an prior arranged grouped event can be scheduled of many persons in larger facilities such as an seated auditorium, or possibly an indoor or outdoor sporting gym or stadium, or as required. In this FIG. 1 the Learning Management System [100] can be seen to manage such a size as may be needed for an arranged grouped event from the smaller normal Classroom [301] up to a larger size to be of any size as requisite as an Event [302].

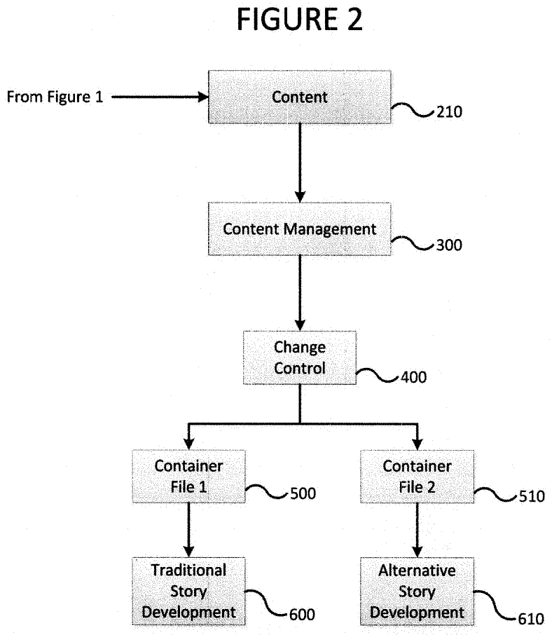

FIG. 1 continues the Learning Management System [100] into its Content [210] that has the command of the requisite files to follow as shown and detailed in FIG. 2, and further development is not required here in FIG. 1.

FIG. 1 then continues the Learning Management System [100] into Testing [220] that is where the participants to be involved for these arranged grouped events can be determined for their abilities and skills in order to evaluate the competent and capable Assessment [330] in order to preselect the best of the candidates that interact in the upcoming arranged grouped event. The Evaluation [340] of all participants is conducted under the supervision of the client who will after all considerations are determined, and then, the client will affirm their best choices for the preselected participants to participate in the Event [303].

In the FIG. 2 the Content [210] from FIG. 1 has been expanded to show the steps as projected herein in this patent in application. The first step shows how all content is directed with Content Management [300] and in turn on the next step down this step manages Change Control [400] which will manage versioning and direct the search in the resource files, Container File 1 [500] and Container File 2 [510] for the required storyline. In this diagrammatic chart section is the Container File 1 [500] that opens the search for a Traditional Story Development [600] that might be perfect to use. The additional Container File 2 [510] that opens the search for an Alternative Story Development [610] that might be viewed if the Traditional Story Development [600] proves unacceptable. Although only single citations are needed to demonstrate these important searches, it is implied that the total range for such a search could be enormous and extensive for desired content.

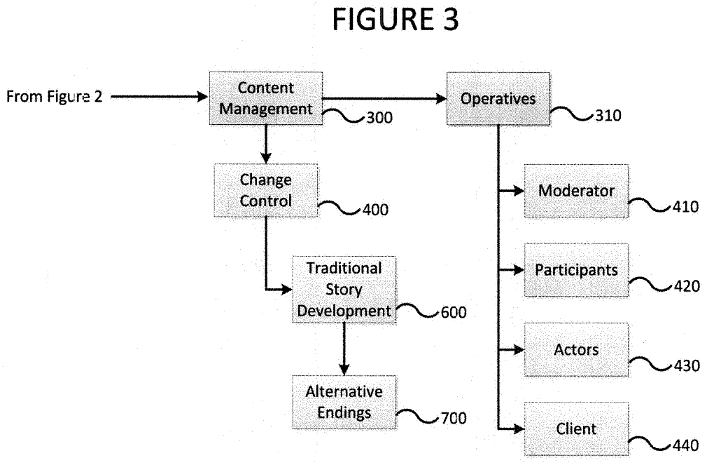

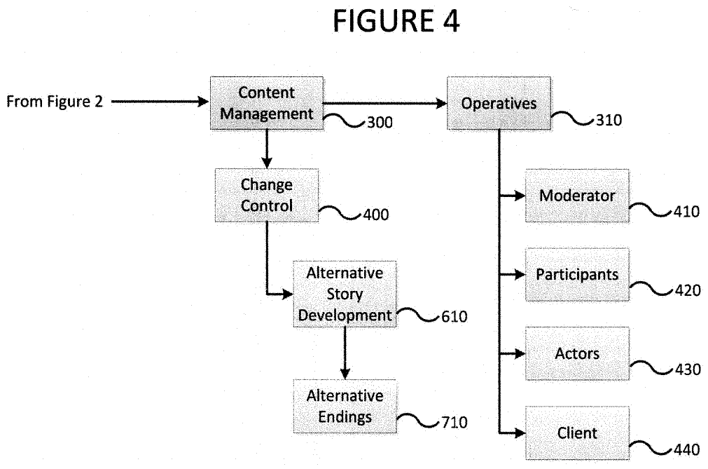

In the FIG. 3 the diagrammatic chart opens up with Content Management [300] from FIG. 2 as shown on the left hand side wherein the Change Control [400] is directed to open a Traditional Story Development [600] to be matched up with several Alternative Endings [700] for an acceptable storyline to use for an arranged grouped event. If such a match up is to be found not sufficient or appropriate for the use intended, then we shall proceed to the FIG. 4 that follows to adjust and continue the search for the storyline that is required by the client. Then, the Content Management [300] will enlist and retain Operatives [310] that are on the right side to seek and hire the needed staff and personnel to place the best storylines into action as requisite to portray all such choices as are to be considered for viewing. In order to perform any storyline that may be selected for viewing, the Operatives [310] shall engage a Moderator [410] to proceed with all preselected Participants [420] that have been evaluated and affirmed by the client as shown in FIG. 1. Then, Actors [430] that have been retained and hired to portray each selected storyline to be viewed by the Client [440] shall assemble and undertake to portray as best possible these selected storylines for the client. The Client [440] having viewed all selected storylines, shall render a verdict for the several best presentations to be retained for further consideration in the final voice vote that acclaims the one best storyline to be presented at an arranged grouped event.

In the FIG. 4 a similar diagrammatic chart to FIG. 3 is presented with identical numbering and descriptions throughout except wherein the choice of an Alternative Story Development [610] is introduced with Content Management [300] directing through Change Control [400] on the left side into the selections of alternative storylines including Alternative Endings [710] suitable for the arranged grouped event.

The Operatives [310] as shown on the right side, will endeavor to engage a Moderator [410] for this situation who in turn will present storylines to the pre-selected Participants [420] for their consideration and selections. Those storylines to be considered the best for the purposes of the client will be affirmed by voice acclamation and be presented to the Actors [430]. The Actors [430] shall assemble and determine how best to portray these choices of storylines to all concerned. After due consideration, the selected storylines will be portrayed and be presented to the Client [440] for consideration and approval by affirmation as the one best storyline selected to be used for the arranged grouped event.

This FIG. 4 has shown the requisite development and processes for all of the choices, including the Traditional Story Development [600] with such Alternative Endings [700] shown in FIG. 3, as well as, the Alternative Story Development [610] and their possible Alternative Endings [710] as shown in this FIG. 4. Herein in FIG. 3 and FIG. 4 the best selections of storylines shall be advanced by voice votes of the preselected Participants [420] and by affirmation of the Client [440], and only then, for a one best presentment to the arranged grouped event.

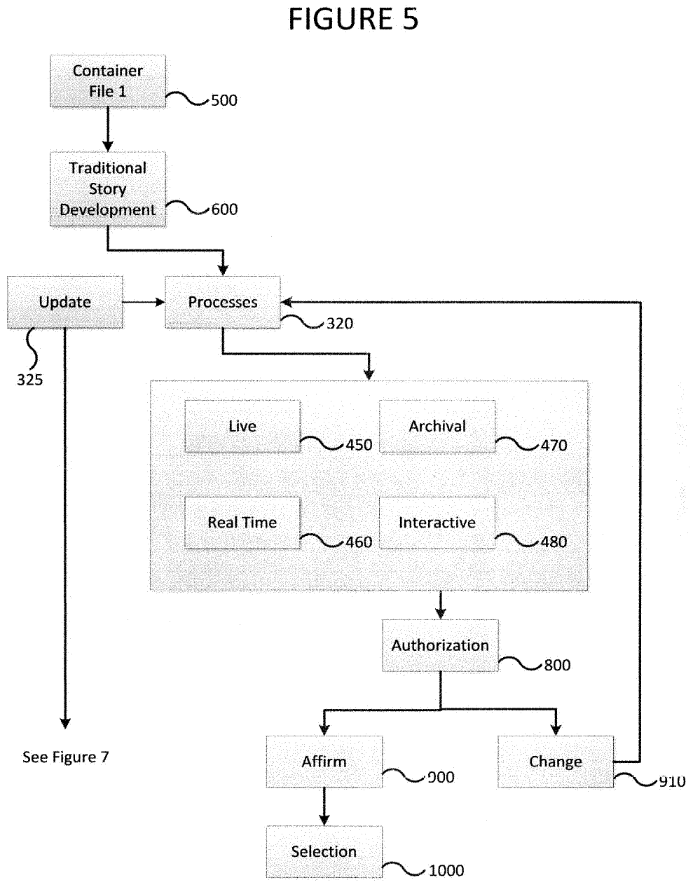

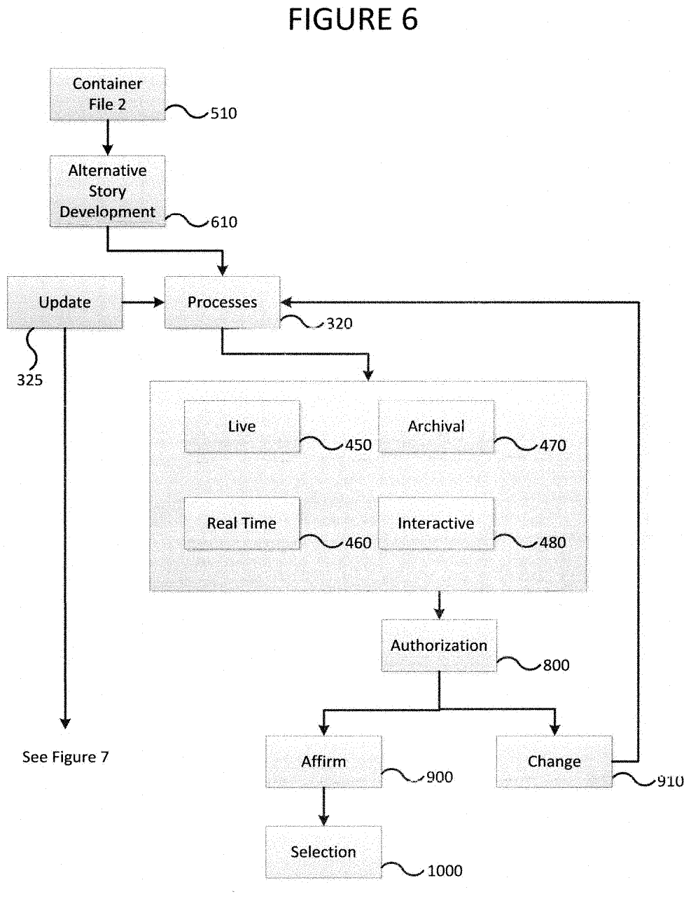

In the following FIGS. 5 and 6 the involvement and exploration into the file containers is shown in the diagrammatic charts that detail how such storylines may be drawn or discovered in these background files that try to develop a satisfactory storyline for an event.

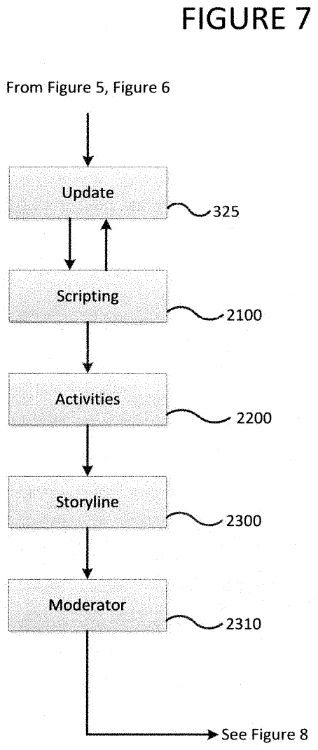

In the FIG. 5 the first item at the top is Container File 1 [500] that will open the files of the Traditional Story Development [600] through the normal Processes [320] that receives from time to time an Update [325] when such a need becomes evident herein, and also as an Update [325] as seen and directed to FIG. 7 for its own merit. Processes [320] control and in turn open the subset block of file storage areas when needed. The first to be shown in the inset of this subset block is Live [450] as directed for a live seated audience at the event. Then, it is Real Time [460] wherein the storyline selected would be recorded to be presented at a later prior scheduled time, or for such subsequent later times requisite for events. The Archival [470] is shown wherein the non-current and older material may be found to consider for usable storylines. The last item is Interactive [480] wherein sections of any or all storylines may joined up to develop sections to be used to achieve a specific desired objective in the storylines that best answer the requirements set forth in the issues introduced by the client.

In the final section of the chart the acceptance by all concerned in trying to assemble and present a storyline that is satisfactory and is the best available answer to deal and bring out the issues presented by the client. An Authorization [800] is given to accept the choices of the storyline as presented and agreed to by the client who will consent and Affirm [900] the Selection [1000], or if unsatisfactory, the client will not accept, and request a Change [910] whereupon the entire Processes [320] is alerted and activated to begin again in search of a satisfactory and acceptable answer.

In the FIG. 6 the first item at the top is Container File 2 [510] that will open the files of the Alternative Story Development [610] through the normal Processes [320] that receives from time to time an Update [325] when such a need becomes evident herein, and also as an Update [325] as seen and directed to FIG. 7 for its own merit. Processes [320] control and in turn open the subset block of file storage areas when needed. The first to be shown in the inset of this subset block is Live [450] as directed for a live seated audience at the event. Then, it is Real Time [460] wherein the storyline selected would be recorded to be presented at a later prior scheduled time, or for such subsequent later times requisite for events. The Archival [470] is shown wherein non-current and older material may be found to consider for usable storylines. The last item is Interactive [480] wherein sections of any or all storylines may be joined up to develop sections to be used to achieve a specific desired objective in the storylines that best answer the requirements set forth in the issues introduced by the client.

In the final section of the chart the acceptance by all concerned in trying to assemble and present a storyline that is satisfactory and is the best available answer to deal and bring out the issues presented to the client. An Authorization [800] is given to accept the choices of the storyline as presented and agreed to by the client who will consent and Affirm [900] the Selection [1000], or if unsatisfactory, the client will not accept, and request a Change [910] where upon the entire Processes [320] is alerted and activated to begin again in search of a satisfactory and acceptable answer.

In the FIG. 7 at the top, the prior citation from issues of the Update [325] are introduced as from prior. FIG. 5 and FIG. 6, and thereupon opens this FIG. 7 with the same Update [325] to detail how this procedure will interact with every storyline that is to be considered for this invention. The process of Update [325] does enter into every storyline that is to be viewed or considered. In this FIG. 7 the opening citation of the process of Update [325] shows a back and forth activity in the first citation in this drawing. This interaction opens with Scripting [2100] that develops and edits the storylines being considered for inclusion in this invention. This FIG. 7 in its diagrammatic chart seeks processes to discover and improve any and all chosen storylines being sought for the client. In the development of this client's issue, it becomes evident that the client has a certain issue at hand to deal with, and wish to ameliorate and try to solve the issue at hand. The concerns and issues of the client can range from a means to mitigate a negative issue, to specific identified educational issues, for new products and services to be introduced into the marketplace.

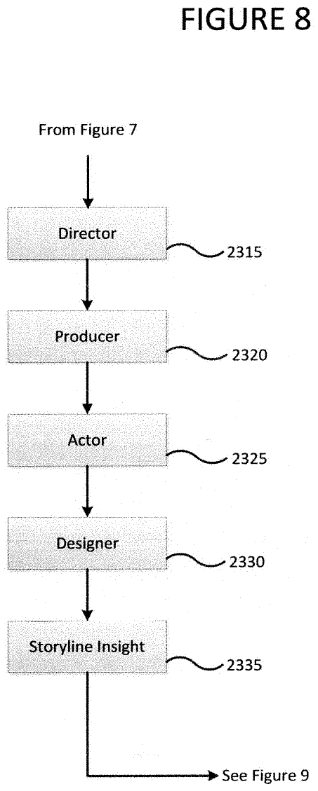

After sufficient Scripting [2100] has taken place, then the actual procedures will begin with the Activities [2200] that involve trained personnel and a staff and Participants [420] and Actors [430] that are all required to accomplish all of what is needed to bring out the one best Storyline [2300] for the purposes of the Client [440]. As these selected stories are accumulated and accepted for possible usage, the Moderator [2310 & 410] will be retained and hired for service as in the FIG. 7. It would seem likely that any, if not all, introduced stories will need to be approved for their purposes throughout the Processes [320] to be developed into an acceptable Storyline [2300] suitable for the purposes intended and for the Client [440]. In this FIG. 7 there is an accumulation of services in the search through Container Files [500 & 510] to locate and identify the best Storyline [2300] to utilize to gain the support and acceptance of the Client [440]. As all services are herein listed, this FIG. 7 points the way to the next arriving FIG. 8 that follows.

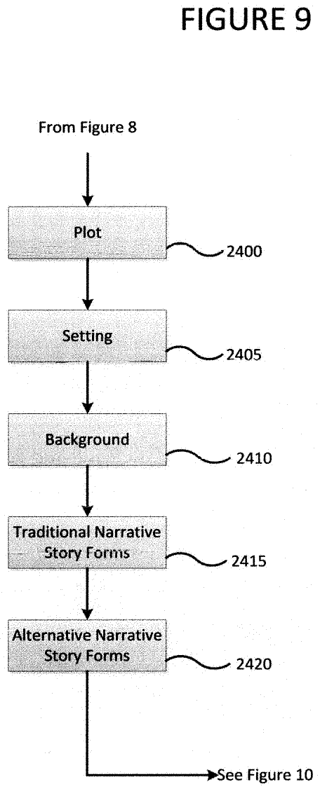

In the FIG. 8 to follow, there is a reference to the prior FIG. 7 at the top, to show that this FIG. 8 continues the same items from the prior FIG. 7. In order to provide the Activities [2200] from FIG. 7, and to support further usage of trained personnel and staff for accomplishing acceptable and superior Storylines [2300], it shows a Director [2315] being retained and hired to oversee all features that would be needed to be successful with the Client [440] proposed acceptable Storyline [2300]. In order to assure success and acceptance the Director [2315] will retain and hire a Producer [2320] to oversee the day to day Activities [2200] and to manage and direct all personnel and staff. One group following is the Actors [2325 & 430] that will portray all chosen appropriate Storylines [2300]. In addition to these required parties there will be retained and hired a Designer [2330]. He will have the responsibility to arrange satisfactory and acceptable backdrops, and a proper stage, and lighting needed in a professional manner that will please everyone concerned. It would be the Director [2315] along with the Producer [2320] and others so concerned to review and decide on the best Storyline Insight [2335] to seek out and embellish so as to provide the very best possible effect to offer to the Client [440] This aspect to seek a best story to use is one of the most important means to deliver success. The final notation directs attention to the next FIG. 9 to follow.

In the FIG. 9 to follow, there is a reference to prior FIG. 8 at the top that this is to show that the FIG. 9 continues the same items from prior FIG. 8. In order to support and investigate further from the Storyline [2300[of FIG. 7, and the Storyline Insight [2335] of FIG. 8 the selected stories are to be reviewed again for their details and structure that will support a single best choice for this situation. Such an effort is needed to ascertain the best choices to take forward for their development and portrayal to meet the expressed needs of the Client [440] in this situation. This FIG. 9 seems timely to look carefully into the plots that are now suggested to be considered.

The opening issue in this FIG. 9 is Plot [2400] that will need to be examined to ascertain the relevance to this proposal as outlined by the Client [440]. This opens up all submissions for their relevance and methods to provide a response and an insight into the details that seemingly answer and enlighten the issues brought up by the Client [440]. If the Plot [2400] seems appropriate and satisfactory, then the investigation shall continue further into the Setting [2405] in order to ascertain its relevance and its support into the prior issues of the Plot [2400]. As these opening sections are approved, then this effort moves further into the Background [2410] of the Storyline [2300] to be certain that all of these factors will fit together. From the prior FIG. 8, further insights and changed emphasis can be brought up by the means of the Storyline Insights [2335] for any adjustments or approvals required. In order to seek a conclusion to these story issues, the next section may provide the answer in a example of Traditional Narrative Story Forms [2415] to complete all efforts with a best and approved Storyline [2300]. If after all of these efforts have not produced a satisfactory result, a further step into the Alternative Narrative Story Forms [2420] would be taken in order to continue the search for the most appropriate story to use to answer the Client [440] issues in this situation.

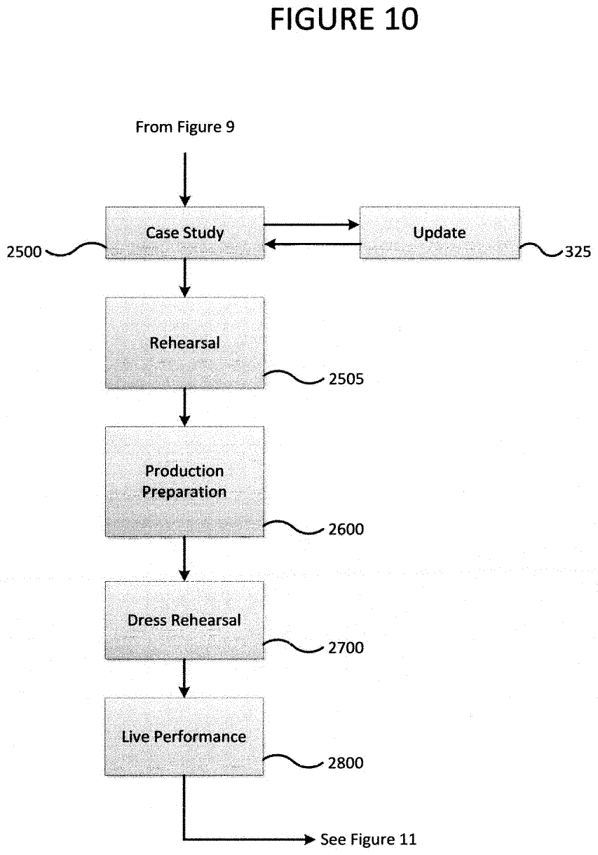

In any event, and with all of the efforts herewith, it would seem likely that a best story would be produced, and then we would be directed from the bottom of this FIG. 9 into the upcoming FIG. 10 that follows. As directed at the top of this new FIG. 10 we are presented with acceptance and analysis of this story in the section identified as Case Study [2500] with its ancillary supporting section at its side as Updates [325[which shows offering back and forth actions. This Update [325] indicates that it will interact with the best of the selected and supported Storylines [2300] and the further developed Storyline Insight [2335] of FIG. 8.

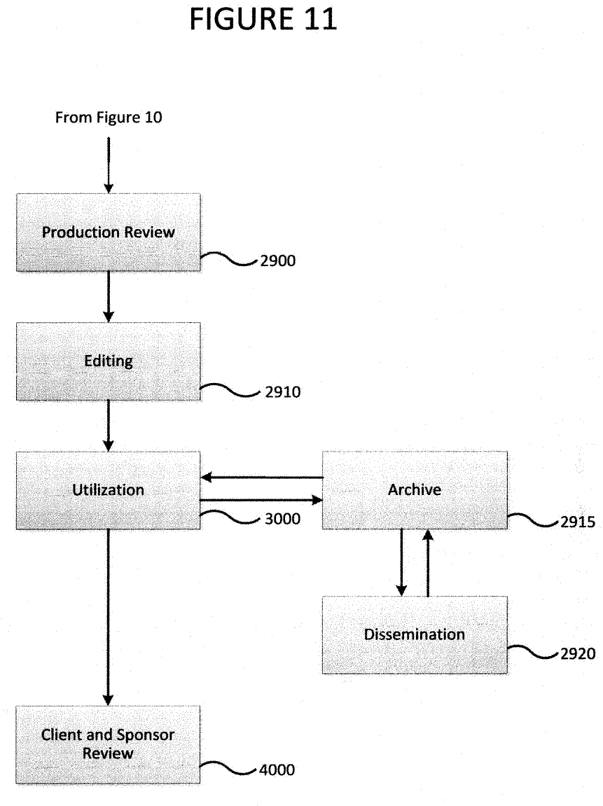

In FIG. 10 the opening actions of the Case Study [2500] after its interactive Updates [325] will then provide the material for a formal Rehearsal [2505] wherein every feature of the chosen Storyline [2300] is to be put in place as an example of the manner of a final product for its arranged grouped event. In any event a successful Rehearsal [2505] will open the way forward for the Director [2315] and the Producer [2320] to assemble personnel and staff and to alert Actors [2325] to study and prepare for a portrayal with the support of their Designer [2330] that also will assemble the stage and scenery for the production of the selected story. If all goes well and this early portrayal is accepted and approved, then an official Production Preparation [2600] will be undertaken. After this official portrayal is accepted, and affirmed by the Client [440], a Dress Rehearsal [2700] will be scheduled for a Live Performance [2800] before the arranged grouped event. Then, any further details or suggestions for improvements will at the bottom of the page be marked as ‘See FIG. 11’.

In the FIG. 11 that follows there is a reference to prior FIG. 10 at the top that this following FIG. 11 continues the same items from the prior FIG. 10. In order to support any further use, or later adaptive use from an Archive [2915] through its Dissemination [2920] process the original portrayal would have to have been recorded for such future purposes.

At the onset of recorded reproduction of the accepted and approved Storyline [2300] that was portrayed for a Live Performance [2800] in FIG. 10, there is then scheduled in the FIG. 11, a Production Review [2900] wherein an Editing [2910] is performed to make certain that all salient features intended have been performed and recorded in the best embodiment possible. Once these introductory tasks have been finished, and the revised production is accepted and approved, then the recorded session is sent into Utilization [3000] to be placed into all best recorded versions for future uses as may arise. As mentioned earlier many such versions are sent to be placed into Archive [2915] which offers a back and forth manner wherein any changes or edits would be undertaken as needed, and then routinely into Dissemination [2920] when requested in such various and diverse versions back and forth as requisite and as requested. The Archive [2915] represents a repository of all such recorded versions, and open to use as needed in any future Storyline [2300] that can be requested by the Client [440] to be used again. In part, the Client and Sponsor Review [4000] represents the final action wherein the issues of the Client [440] that originated this project have been completed, and with its availability as needed in any various edited and recorded forms upon proper request or future supportive uses. It is of interest that the Client may engage a Sponsor that provides outside review and supportive activities including arranged group event sponsorship through affinity and association of common interests and concerns. Furthermore, these requests would require an authorization from the Client [440] or his representatives, and such copies as required would then be available from Dissemination [2920] as authorized by the Client [440]. Other uses can be made of sections and prior histories that are not direct to the current interests of the Client [440], and these can be drawn from the Archive [2915] as a routine stored material to be used in other presentations when properly requested.

The FIGS. 1 through 11 exemplify the aforesaid stated activities, and the Claims as presented for my novel invention. I hereby ask for a Letters Patent to be granted and issued upon this invention.

### IN BEST EMBODIMENT

In best embodiment, the Live Real Time Interactive Learning Event (LRTILE, the Event) environment framework of processes and procedures operating within the Learning Management System; provides benefits to all operatives, participants, and audiences that extend understanding and self-awareness through engagement with the subject matter revealed during the LRTILE presentation session.

In accordance with one or more embodiments, this invention can provide benefits to operatives through the utilization of coexisting Traditional Storyline Development and Alternative Storyline Development storylines that adhere to a defined seven phase approach that engages the said operatives, including the versioned and re-versioned discussions within the Interactive Case Study.

This invention has certain attributes of the operatives including the following for discussion purposes:
1) A live, real-time (in both senses) interaction among our Operatives, Traditional Storyline Developments, Alternative Storyline Developments, and Interactive Case Studies;
2) A more direct, immediate and impactful experience within the Event for Operatives, Traditional Storyline Developments, Alternative Storyline Developments, and Interactive Case Studies as evidenced in the interview, coaching, re-coaching and re-do sections;
3) A living process of metamorphoses of the Traditional Storyline Developments, Alternative Storyline Developments, Interactive Case Studies and Operatives beyond the limitations and restrictions of the static, pre-conceived and pre-recorded Traditional Storyline Development model experienced by consumers in the ‘interactive creative content experience’ options offered by Netflix, HBO, Disney, VR companies, an Alaskan reality-TV show, a new [interactive] professional football league, and others;
4) A living, evolving engagement among all Interactive Case Study Operatives and Collaborators, including Audience Members/Participants; wherein the latter become active contributors, and eventually collaborators, to the process of Interactive Case Study creation, re-creation and metamorphoses;
5) With the aggregation of #1, #2, #3, and #4 listed herein; a living, unlimited and infinite model Traditional Storyline Development, Alternative Storyline Development and Interactive Case Study creation, re-creation and metamorphoses is created;
6) Creation, installation, utilization and maintenance of a living, interactive platform of creative content, comprised of a multitude of states, levels and interfaces within and among autonomous aesthetic, learning and experimental sets of inner, inter-and multi-dimensional consciousness as a Holism. Said platform can also operate as a cross-fertilization force and medium.
   These preceding attributes represent a portion of the features, processes, and procedures that are utilized in the creation, re-creation, and metamorphoses of this invention and are combined with other components described within other sections of this Learning Management System specification.

### IN ANOTHER EMBODIMENT

In another embodiment, these images represent another form of Content and exist as specimens of library writings and illustrations in association with this detailed description that are more clearly identified in these examples.

The following examples of library writings and illustrations are included for instructive purposes that identify examples of mankind's early attempts at organized thoughts and descriptive revelations of then current times and settings, people, places, contemplations, and such markings for memorial purposes. These examples may utilize various forms of language, writing, and marking including: Cuneiform, Hieroglyphics, Gnostic, Coptic, Messianic, Hebrew, Greek, etc.

A brief introduction to the library writings References 1-8 are below and include: time of origin (range); language, writing, illustration, image; identification of same; author, citation library (collection, location, and public domain):

I claim:

1. An interactive participant choice of final plot development comprising essentially of these following items:
a. a storyline of interest;
b. actors will portray characters in said storyline;
c. a point of decision in the storyline;
d. a moderator will interrupt said storyline;
e. participants discuss storyline development;
f. moderator shall interact with actors;
g. participants shall interact with moderator;
h. participants shall interact with actors;
i. participants shall interact with storyline being developed by characters portrayed by actors;
j. participants shall interact with actors portraying characters interacting with moderator;
k. moderator will summarize several choices;
l. discussion between actors portraying characters by moderator;
m. discussion between actors portraying characters by participants;
n. coaching session between actors portraying characters by moderator;
o. coaching session between actors portraying characters by participants;
p. re-coaching session between actors portraying characters by moderator;
q. re-coaching session of actors portraying characters by participants;
r. participants acclaim by voice one best choice of storyline development; &
s. actors will portray final storyline development selection.

2. The choice of final plot development of claim 1 further comprising said storyline introduces a point of decision wherein choices of new final ending are to be evident to participants.

3. The choice of final plot development of claim 1 further comprising said moderator will interact with actors.

4. The choice of final plot development of claim 2 further comprising said actors will open discussion with said participants.

5. The choice of final plot development of claim 2 further comprising said moderator will open discussion with said participants.

6. The choice of final plot development of claim 4 further comprising said moderator will summarize several best scenarios offered by said participants.

7. The choice of final plot development of claim 6 further comprising said participants acclaim by voice one best choice for new final plot of storyline.

8. The choice of new plot development of claim 7 further comprising said actors portraying storyline throughout shall present said new final plot as chosen.

9. Interactive participant choice in arranged group events shall comprise that said events comprise participants with essentially these stated purposes, singly, and in combinations, but not limited to, these items:
a. educational;
b. teaching;
c. informational;
d. commercial;
e. corporate;
f. government;
g. military;
h. community;
i. to interact in discussion;
j. to learn evaluation;
k. to experience decision making;
l. to select choices;
m. to collaborate in an interactive learning experience;
n. to gain knowledge of self; &
o. to gain knowledge of others.

10. The said participant in said event of claim 9 further comprising that the moderator be available to open discussion with said participants at point of decision in storyline at said event.

11. The said participants in said event of claim 10 further comprising that at the point of decision in said storyline that several, if not many, choices of the new final ending of said storyline be discussed with said participants.

12. The said participants in said event of claim 11 further comprising that said participants will acclaim by voice vote the one best selection for said new final ending.

13. An arranged grouped event shall comprise pre-selected interactive participants, and all concerned, will essentially require, singly, and in combinations, but not limited to, these following items:
a. a normal classroom size;
b. be of any size larger;
c. to extend to additional locations;
d. to be connectable by voice means;
e. to be connectable by visual means;
f. to be scattered in locations;
g. to be scattered yet connectable for content;
h. to be pre-selected for a specific issue;
i. to gather participants for a specific issue;
j. to gather participants for an interactive learning experience;
k. assemble participants for education on a topic;
l. assemble for commercial interests;
m. assemble for a private reason;
n. assemble for a public reason;
o. assemble for a corporate requirement; &
p. assemble for any lawful reasons.

14. The said event of claim 13 further comprising said interactive participants as pre-selected by said client and sponsors will be adaptable and informed of issues under consideration for said event.

15. The said event of claim 14 further comprising said interactive participants being pre-selected by said client and sponsors will possess qualifications and skills requisite to manage with conditions upcoming in said event.

16. The said event of claim 15 further comprising said interactive participants being pre-selected by said client and sponsor will be chosen to evidence an open mind to be unprejudiced of issues being deliberated by client and sponsors.

17. The said event of claim 16 further comprising said interactive participants as pre-selected by client and sponsors be presented by said moderator several choices in summary to consider.

18. The said event of claim 17 further comprising said interactive participants shall by voice vote acclaim one best selection for said new final ending.

19. Interactive participants in arranged grouped events comprise a pre-selected group of persons knowledgeable and informed of issues to discuss through efforts of a moderator that conducts said event.

20. The said interactive participants in said arranged grouped event of claim 19 further comprises that said event has sponsorship with a client and sponsors well qualified in their field to desire the best choice in a pre-selected storyline in its new final ending.

21. The said interactive participants in said arranged grouped event of claim 20 further comprises that some of the said interactive participants have been interviewed wherein their qualifications and skills are accepted and pre-selected by said client and sponsors.

22. The said interactive participants in said event of claim 19 further comprising
that said interactive participants being those pre-selected by client and sponsors are chosen to be individuals with experience and knowledge of said issues being considered by client and sponsors.

23. The said interactive participants in said event of claim 19 further comprising that those pre-selected are chosen have good communication skills with an open balanced mind of said issues being considered by client and sponsors.

24. The said interactive participants in said event of claim 23 further comprising said interactive participants as pre-selected by said client and sponsors are adjudged competent to interact with said moderator on all choices that arise out of said event.

25. The said interactive participants in said event of claim 24 further comprising said pre-selected participants affirmed by client and sponsors will be chosen to have a commitment to improve the issues being considered by said client and sponsors.

26. The said interactive participants in said event of claim 19 further comprising that those pre-selected are chosen have the courage to speak the truth in an unbiased manner to the issues at hand, and not their personal view of truth.

27. The said interactive participants in said event of claim 19 further comprising that those pre-selected are chosen have the sensitivity to absorb mutually defined goals of dramatic and cultural issues at hand that affect the client and sponsors.

28. Arranged grouped events comprise training utilizing an interactive case study wherein client and sponsors seek to assess its cultural identity by the means of issues highlighted in the training experience.

29. The arranged grouped events of claim 28 further comprising said interactive case study model that involve pre-selected interactive participants yield scenarios from its grouped effort that convey cultural truths.

30. The arranged grouped event of claim 29 further comprising said pre-selected participants will yield best practices in client and sponsor's business model.

31. A learning management system comprising client and sponsors support in an arranged grouped event wherein issues of said client and sponsors may be reviewed to be processed as interactive case studies through these elements:
a. location;
b. content; &
c. testing.

32. The learning management system of claim 31 further comprising that the locations be of a size with services suitable for said event.

33. The learning management system of claim 32 further comprise said locations can provide services capable for remote locations.

34. The learning management system of claim 31 further comprising said content may be presented in traditional story form.

35. The learning management system of claim 34 further comprising said content can accommodate alternative story endings requiring alternative story development.

36. The learning management system of claim 31 further comprising said testing can provide measurable participants understanding with issues satisfactory to client and sponsors.

37. The learning management system of claim 31 further comprising said testing can provide participant assessment for client and sponsors evaluation to pre-select participants for the arranged grouped events.

38. A learning management system comprises content management with change control to activate any and all files as requisite for an arranged grouped event.

39. The said learning management system of claim 38 further comprising said change control can select files as requested by moderator operative.

40. The said learning management system of claim 39 further comprising said moderator operative engage pre-selected interactive participants to discuss any storyline developments authorized by client and sponsors.

41. The said learning management system of claim 40 further comprising said pre-selected interactive participants following discussion acclaim by voice vote the one best choice for said storyline.

42. The said learning management system of claim 41 further comprising said moderator operative interact with actors that portray characters portraying said one best choice as authorized by client and sponsors for presentation to said arranged grouped event
